(19) United States
(12) Patent Application Publication
(10) Pub. No.: US 2015/0236977 A1
(43) Pub. Date: Aug. 20, 2015

(54) MANAGEMENT COMPUTER, COMPUTER SYSTEM, AND INSTANCE MANAGEMENT METHOD

(71) Applicant: Hitachi, Ltd., Tokyo (JP)

(72) Inventors: Atsumi Terayama, Kawasaki (JP); Akihisa Nagami, Yokohama (JP); Noriko Nakajima, Machida (JP); Toshio Otani, Fujisawa (JP)

(73) Assignee: Hitachi, Ltd., Tokyo (JP)

(21) Appl. No.: 13/701,183

(22) PCT Filed: Nov. 9, 2012
(86) PCT No.: PCT/JP2012/007203

§ 371 Date: Nov. 30, 2012

(51) Int. Cl. H04L 12/923; H04L 12/24; H04L 12/26

(52) U.S. Cl. CPC H04L 47/762; H04L 43/065; H04L 41/0873

(57) ABSTRACT

In the case of performance deterioration or performance excess with respect to current resource assignment, both processing capacity and resource use efficiency are optimized by an appropriate configuration change. For that purpose, the present invention proposes an appropriate migration measure to a request for performance improvement. Whether or not the server in which performance deterioration or excess occurs and another server influence each other in performance is identified, and it is determined whether a change of a resource amount in the same device is appropriate or migration to another device is appropriate. Regarding the migration measure, after feasibility is checked, items for improvement are presented together with required time and cost taken for the migration, and merits and demerits of the configuration change work are quantitatively indicated (see FIG. 4).

### TECHNICAL FIELD

The present invention relates to a management computer, a computer system, and an instance management method and relates to a technology for managing assignment of resources in a computer system in which a virtual server and a physical server are mixed, for example.

### BACKGROUND ART

A server virtualization technology has spread and integration of a plurality of virtual servers for constructing a business information system on single hardware has become general. Since the virtual servers share resources provided by a single physical server (virtual server host), they are subjected to an influence on performances of the other virtual servers on the same virtual server host. If a purpose or type of processing cannot be grasped, the influence on the performances (such as an increase/decrease of a processing load) cannot be easily forecasted. For example, in the case of the increase/decrease of a processing load, the larger the processing load of one of the virtual servers becomes, the more processing resources are deprived of on the other virtual server, whereby performance deterioration might be incurred. In this point, by operating only one virtual server on one virtual server host, this performance influence can be eliminated. However, processing of a hypervisor implementing the server virtualization function becomes overhead, and all the resources of the physical server cannot be utilized. Particularly, in the field with priority given to calculation performances over ease of operation management such as scientific technological calculations or business intelligence, the processing overhead is not acceptable. Moreover, a general virtual server environment has disadvantages that complexity of a structure is increased by provision of an abstraction layer such as the hypervisor, a burden of management increases, an introduction cost of the hypervisor itself is needed and moreover, a failure in one hypervisor or a virtual server host might affect a plurality of systems.

Then, there can be an operation method in which a physical server not having a hypervisor is used as a processing environment as it is even in an environment where a virtual server is present. Such a physical server is referred to as a bare metal server, which can utilize all the processing performances provided in one hardware device and can be stably operated without being affected by the other servers. Moreover, the bare metal server is an operation method which has been a mainstream, and sufficiently reliable existing technologies and assets such as management software can be also utilized.

On the other hand, an Operating System (OS) on the server and controlling resources to be provided to an application has an internal structure called a hardware abstraction layer, and if some degree of compatibility is satisfied, it can be operated on another physical hardware. Thus, for example, the application and its data having operated in a virtual server can be migrated to the bare metal server together with the OS as long as the compatibility is satisfied. Similarly, migration from the bare metal server to the virtual server is also possible, and software implementing those migration functions called P2V/V2P in general is provided.

By means of combination of the above-described server virtualization technology, bare metal server operation management technology, and migration technology, a possibility is suggested that a business system can be operated in an environment in which the virtual server and the bare metal server are arbitrarily mixed. In such environment, such operation can be realized that suitable processing base is used in accordance with requirements of the business system such that, if resource use efficiency is given priority, the virtual server is used, while if processing performance or operation stability is given priority, the bare metal server is used. In PTL 1, a method of migrating a system from a virtual server to a bare metal server as one of technologies to realize such operation is disclosed.

On the other hand, as a recent trend, cloud computing has been flourished. In the cloud, an operation management cost is reduced by aggregating a large number of servers to a platform by virtualization and integrally managing them, and a rising dependence on an information system is responded. One of features of such cloud is enhancement of self-service by users and it is recognized as a standard in cloud operation management.

Particularly in the IaaS (Infrastructure as a Service) cloud, creation of a processing environment and configuration change called server instances (hereinafter referred to simply as an instance) are executed by the user himself/herself who constructs an information system. The instance corresponds to one virtual server in general, and the user introduces an OS and an application therein and constructs a desired system. That is, works which had been executed by an administrator who asked for requirement from users are transferred to the user, and environment construction by self-service of the user himself/herself has been realized. As a result, a work burden on the administrator is reduced, and the user can construct a desired environment rapidly.

One of important systems in realizing this self-service is a catalog describing a machine configuration of the server. Though the user has knowledge on system requirements he/she wants to construct in view of applications, he/she does not know which machine configurations are appropriate or the configuration of the entire device for operating them in many cases since it is not under the control of the user. Thus, the administrator creates a plurality of patterns of typical server configurations as a catalog, considering factors such as an application of the virtual server, sizing of a physical resource and the like and presents the catalog to the user. On the other hand, the user creates an instance on the basis of those catalogs. Even if the catalog does not indicate an optimal configuration for the user's system in a strict sense, the user can customize the instance as necessary after starting actual operation and adjust it for the machine configuration conforming to a processing load at that time. As a result, the user can uniquely determine and select a configuration suitable for the application to be introduced by the user, and the administrator can save labor for administration since the work of confirming the requirements with the user each time the virtual server is to be created is no longer necessary. Moreover, since dynamic resource addition or change of a virtual server host can be performed relatively easily particularly in the virtual server, the resource use efficiency of the system can be improved without being noticed by the user by using a technology of automatically changing the configuration in accordance with the processing load of the physical device. PTL 2 discloses such technology of automatic configuration change.

The catalog can be considered to be positioned between the user using the IaaS cloud and a provider (including the administrator) providing the instance as service as a system for clarifying a requirement on the user side for the instance and a condition when the provider provides the instance. Though matters described on the catalog are different depending on a relationship between the user and the provider, they include descriptions on the configuration of the instance (resources assigned to the instance) and usable management functions in many cases. Since those descriptions depend on the configurations and functions of hardware and software which are bases of the cloud, they are not totally arbitrary but several levels are provided on the basis of the application of the instance and the configuration of the bases in many cases. In this description, the levels of the instance set for the type and quantity of the resources to be assigned and the management function will be called service levels.

Then, by providing the above-described bare metal server in the cloud environment, it is expected that a high performance/high quality server instance can be provided by self-service of the user similarly to the case of the virtual server.

### CITATION LIST

### Patent Literature

PTL 1: JP Patent Publication (Kokai) No. 2009-145931 A
PTL 2: JP Patent Publication (Kokai) No. 2011-118525 A

### SUMMARY OF INVENTION

### Technical Problem

However, if the bare metal server is to be provided as a server instance (also referred to as bare instance or physical instance), differences might be occurred such that items different from those of the virtual server is described in the catalog or a resource amount to be assigned or management functions that can be applied are different due to a difference in attributes from the virtual server. These differences can be understood as advantages that diversified service levels can be provided on one hand, while users not having specialized knowledge on operation management of the bare metal server might be baffled on the other hand. That is because, if the user wants to extend a server configuration, the user can easily extend it by rewriting a setting file or the like in the case of a virtual instance but cannot easily make a dynamic change in the case of a bare instance.

Therefore, even if the user feels that the performance is not satisfactory for the processing demand or the performance is excessive for the processing demand, it is difficult for the user to determine which type of resources should be increased/decreased by how much. For example, if required time is fluctuated depending on timing regardless of a similar application used and similar processing executed on a virtual server, for example, the user cannot determine which is more preferable to migrate to a bare metal server or only to add a virtual resource. This is caused since a correspondence relationship between the server instance and the physical device is hidden by the abstraction structure of the catalog or the like. More specifically, this is caused since the user does not know on which of a virtual server host the virtual server used by the user is operating and a load tendency of another virtual server with which the resource is shared.

In order to realize the self-service by the user (such that the user who wants to use the application decides on specification of an instance and extends it or the user determines a change of a configuration of a server in accordance with a processing load of the application, for example), a system that presents an appropriate service level together with a cost required for operating it is needed so that the user can select a configuration suitable for the desired application. The cost here refers to a price paid by the user for the works required for operation management of the instance. As described above, in many cloud environments, upper limit values and prices are set for usable resources and functions. Thus, the user has a desire to reduce excess resource use and rationalize the cost while the user also wants to use an instance having sufficient performances for operation of a desired application.

The present invention was made in view of the above-described circumstances and provides a technology which enables setting/change of a server instance, considering a balance between improvement of use efficiency of a server resources and cost reduction.

### Solution to Problem

In order to solve the above problems, in the present invention, a management server (management computer) determines a factor of performance influences and calculates appropriate migration destination candidates that can solve the performance influences in accordance with a configuration change request by a user or a configuration change request on the basis of a detection result of performance deterioration or performance excess. Here, the management server obtains performance information of each server device, a network device, and a storage apparatus and holds it as a history. Moreover, the management server specifies a factor or a portion where performance deteriorates on the basis of the obtained performance information. Furthermore, the management server calculates a measure for relaxing the performance deterioration, obtains information of a device which becomes a candidate for a configuration change of an instance, confirms device compatibility (presence of a device driver and the like) and then, determines a migration destination candidate.

That is, the present invention relates to a computer system having a plurality of physical servers, at least one storage apparatus, and a management computer managing them. The management computer holds configuration information of an instance on the physical server and performance information of the physical server and the storage apparatus on a memory. The management computer executes performance competition determination processing in which, in response to a configuration change request of an instance, the performance information is referred to and whether or not the instance as a target of the configuration change is competing with another instance for a processing demand is determined in a target physical server for which the instance as a target of the configuration change is set, candidate creation processing for creating a candidate for a configuration change method of the instance as a target of the configuration change on the basis of a result of the performance competition determination processing, and candidate provision processing for providing the created candidate of the configuration change method to a user (client computer).

Here, the at least one physical server is a first server which has a virtualization mechanism, divides and assigns the resource of the physical server to the instance and has the instance function as a virtual instance. At least one physical server other than the first physical server is a second server which assigns all the resource of the physical server to the instance and has the instance function as a virtual instance. The management computer presents the virtual instance and/or the configuration of the physical instance as a candidate of the configuration change method.

### Advantageous Effects of Invention

According to the present invention, setting/change of a server instance can be made, considering a balance between improvement of use efficiency of a server resource and cost reduction.

Further characteristics relating to the present invention will be made apparent from the description of this description and the attached drawings.

### BRIEF DESCRIPTION OF DRAWINGS

FIG. 1 is a diagram illustrating a physical configuration of a computer system according to a first embodiment of the present invention.

FIG. 2 is a diagram illustrating an example of a physical system unit configuration according to an embodiment of the present invention.

FIG. 3 is a diagram illustrating a logical configuration of a computer system according to the embodiment of the present invention.

FIG. 4 is a diagram illustrating a concept of a function realized by the first embodiment 1 of the present invention.

FIG. 5 is a diagram illustrating a configuration example of an improvement measure list according to the embodiment of the present invention.

FIG. 6 is a diagram illustrating elements constituting a management program according to the embodiment of the present invention.

FIG. 7 is a diagram illustrating a configuration example of an instance management table in the embodiment of the present invention.

FIG. 8 is a diagram illustrating a configuration example of a migration condition management table in the embodiment example of the present invention.

FIG. 9 is a diagram illustrating a configuration example of a device management table in the embodiment of the present invention.

FIG. 10A is a flowchart (1) for explaining migration measure calculation processing in the first embodiment of the present invention.

FIG. 10B is a flowchart (2) for explaining migration measure calculation processing in the first embodiment of the present invention.

FIG. 11 is a diagram for explaining a concept of a catalog search method in a second embodiment of the present invention.

FIG. 12 is a diagram illustrating a configuration example of the migration condition management table and a configuration example of a migration management portion in a third embodiment of the present invention.

### DESCRIPTION OF EMBODIMENTS

Embodiments of the present invention will be described below by referring to the attached drawings. In the attached drawings, functionally same elements might be displayed with the same reference numerals. The attached drawings show specific embodiments and implementation examples according to the principle of the present invention but these are for understanding of the present invention and shall never be used for interpreting the present invention in a limited manner.

In this embodiment, explanation sufficiently in detail for those skilled in the art to put into practice is made, but other implementations/embodiments are possible, and it should be understood that change of configurations/structures and various replacement of elements are possible without departing from a range and a spirit of the technical idea of the present invention. Moreover, all the elements described in the embodiments and their combinations are not necessarily indispensable for solution of the present invention.

In the explanation below, information of the present invention will be expressed as an “aaa table”, an “aaa list” and the like but these types of information may be expressed in a way other than data structures such as a table, a list, a DB, a queue and the like. Thus, in order to indicate that the information does not depend on the data structure, the “aaa table”, “aaa list” and the like might be referred to as “aaa information”.

When contents of each piece of information are explained, expressions such as “identification information”, “identifier”, “name”, “title”, “ID” are used but they can be replaced by each other.

In the explanation below, “each processing portion” such as a service level determination portion, a migration management portion and the like might be used as the subject, but since executed contents of each processing portion is executed by a processor as a part of or the whole of a program, the processor may be used as the subject in the explanation. Moreover, a part of or the whole of each processing portion (program) may be realized by dedicated hardware.

Hereinafter, a collection of one or more computers, each managing a computer system and displaying information for display of the present invention might be called a management system. If the management computer displays the information for display, the management computer is the management system. Moreover, a combination of the management computer and the computer for display is also the management system. Moreover, a plurality of computers may realize processing equal to that of the management computer for management processing at a higher speed and with higher reliability, and in this case, the plurality of computers (including a computer for display if the display is made by the computer for display) is the management system.

### (1) First Embodiment

A first embodiment relates to a system which specifies a factor of a performance influence in accordance with a user's request and presents a candidate for an appropriate migration measure in accordance with the result.

### Configuration of Computer System

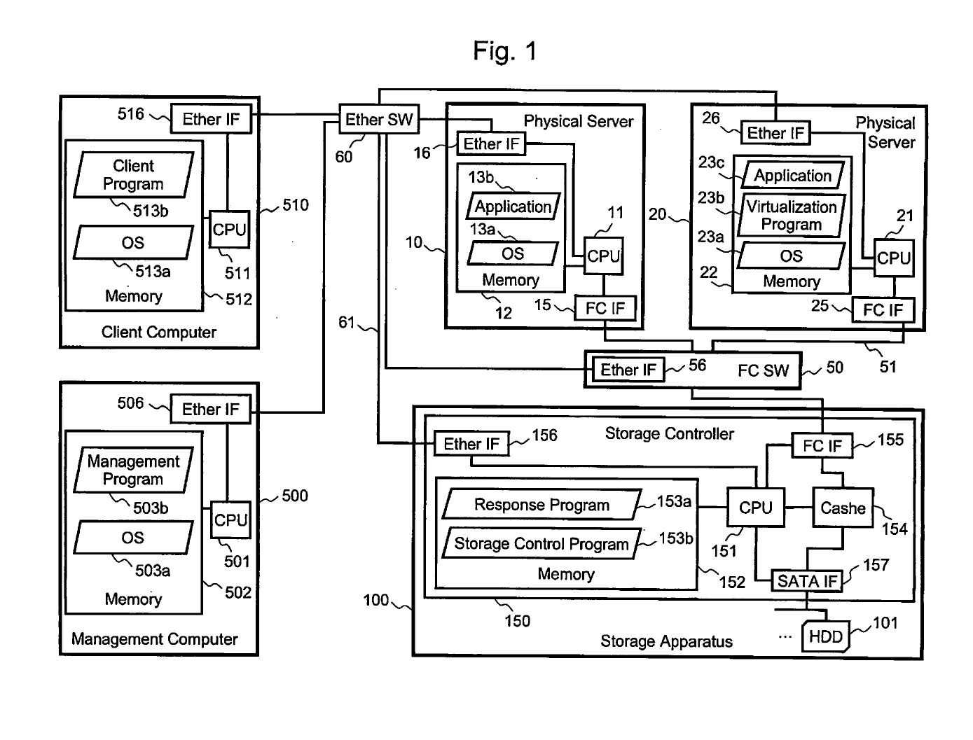

FIG. 1 is a diagram illustrating a physical outline configuration of a computer system according to a first embodiment of the present invention. This computer system is provided with at least one first physical server 10, second physical server 20, storage apparatus 100, client computer 510, and management server (management computer) 500, respectively, and is further provided with a network 51 and a network 61 connecting them to each other.

The first physical server 10 is provided with a CPU 11, a memory 12, a fiber channel interface (FC IF) 15, and an Ethernet (hereinafter registered trademark) interface (Ether IF) 16. At least an OS 13a is stored in the memory 12 and realizes a function of providing a processing resource to an application 13b operating on the physical server 10 by calculation processing of the CPU 11. Hereinafter, in a meaning particularly that a virtualization program is not operating and the OS 13a is directly operating on the physical server 10, the physical server 10 might be called a bare metal server. The FC IF 15 conducts communication with other devices through the network 51 and is used with a purpose mainly of connecting a storage resource. Communication standards other than the fiber channel may be used as long as it is mutual connection means for achieving the same purpose and may be provided in plural depending on the application. The Ether IF 16 conducts communication with other devices through the network 60 and is used with the purpose of connecting to other physical servers 10 and 20, the client computer 510, and the management computer 500. Those in compliance with communication standards other than the Ethernet may be used as long as it is mutual connection means for achieving the same purpose and may be provided in plural depending on the application.

The second physical server 20 is provided with a CPU 21, a memory 22, an FC IF 25, and an Ether IF 26. At least an OS 23a and a virtualization program 23b are stored in the memory 22 and realize a function of dividing the physical server 20 into one or more resource regions by calculation processing of the CPU 21 and providing them to the other OS or application 23c. The virtualization program 23b does not necessarily have to be separated from the OS 23a but may be implemented as one of modules in the OS 23a or may be implemented as the OS 23a itself as long as a function of dividing the physical server 20 into one or more resource regions is provided. Hereinafter, those implementing the function of the virtualization program 23b might be called hypervisors. Moreover, a part of the hardware of the physical server 20 is cut out as a closed resource region by the function of the virtualization program 23b. This resource region constitutes hardware of one logical server called a virtual machine and the second physical server 20 might be called a virtual machine host. Details of the FC IF 25 and the Ether IF 26 are similar to those of the first physical server.

The network 51 is to connect the one or more physical servers 10 and 20 and one or more storage apparatuses 100 to each other. As a result, the physical servers 10 and 20 communicate with the storage apparatus 100, and a storage resource required when the applications 13b and 23c operate is made usable. On the network 51, one or more fiber channel switches (FC SW) 50 may be interposed. Configuration of the FC SW 50 is set by the management computer 500 through the network 61 to which the Ether IF 56 is connected.

The network 61 is used mainly for the following three purposes. A first purpose is to provide service communication between the client computer 510 and the physical servers 10 and 20. For example, the physical server 10 receives a processing request or data of a processing target from the client computer 510 and transmits data processed or created by the application 13b again to the client computer 510. A second purpose is to make a configuration change of the physical servers 10 and 20 in relation with the service communication. For example, the new application 23c is introduced into the physical server 20 or a resource region called a virtual server is created on the virtualization program 23b. A third purpose is to change a configuration of the data network 51 between the physical servers 10 and 20 and the storage apparatus 100. For example, a unit of a storage resource called a volume is created through a storage control portion 150 of the storage apparatus 100, and a logical communication path with the physical server is set so that the storage resource can be used.

The storage apparatus 100 is a collection of a plurality of physical storage devices 101 and is provided with a storage control portion 150 for controlling the devices in a centralized manner and provides a storage resource for storing data to the other devices such as the physical servers 10 and 20. As illustrated in FIG. 1, the physical storage device 101 is a hard disk drive (HDD), for example, and a nonvolatile storage device called a solid state drive is also used. The storage control portion 150 is provided with a CPU 151, a memory 152, a cache 154, an FC IF 155, an Ether IF 156, and a Serial Advanced Technology Attachment interface (SATA IF) 157. in the memory 152, programs including at least a response program 153a responding to a reading/writing request and a storage control program 153b controlling a logical configuration of the device is stored. The function of the storage apparatus 100 is realized by calculation processing of these programs by the CPU 151. The cache 154 is used mainly for improving a response performance of the storage resource to the reading/writing request of the physical server. The FC IF is to communicate with the other devices through the network 51 and is used mainly for the purpose of connecting to the physical servers 10 and 20. Any communication standards other than the fiber channel may be used as long as it is mutual connection means for achieving the same purpose and may be provided in plural depending on the number of the physical servers. The Ether IF 16 conducts communication with the other devices through the network 60 and is used mainly for the purpose of connecting to the management computer 500.

The management computer 500 is provided with a CPU 501, a memory 502, and an Ether IF 506 and mainly has a function of changing a configuration of the other devices. In the memory 502, at least an OS 503a for controlling hardware of the management computer and a management program 503b are stored. The function of the management computer 500 is realized by calculation processing of the OS and the programs by the CPU 501. The management program 503b may be operated in plural depending on the application as long as a processing capacity allowed by the management computer 500 is not exceeded. Details of the management program 503b will be described later. The Ether IF 506 is to communicate with the other devices through the network 60.

The client computer 510 is to enjoy the services provided by the application programs on the physical servers 10 and 20 and is operated by the user. The client computer 510 is provided with a CPU 511, a memory 512, and an Ether W 516. In the memory 512, at least an OS 513a for controlling hardware of the client computer and a client program 513b are stored. The function of the client computer 510 is realized by calculation processing of the OS and the programs by the CPU 511. The client program 513b provides a function of a user interface such as communication with the application program on the physical server and display of a request for service processing and a processing result or communication with the management program 503b on the management computer 500 and changes of a configuration of the system within a range allowed for the user. The client program 513b may be special implementation for collaboration with other programs as long as the above-described function is realized or may be a general-purpose program such as a Web browser as long as an appropriate communication protocol is used.

### Physical Arrangement Example of Computer System

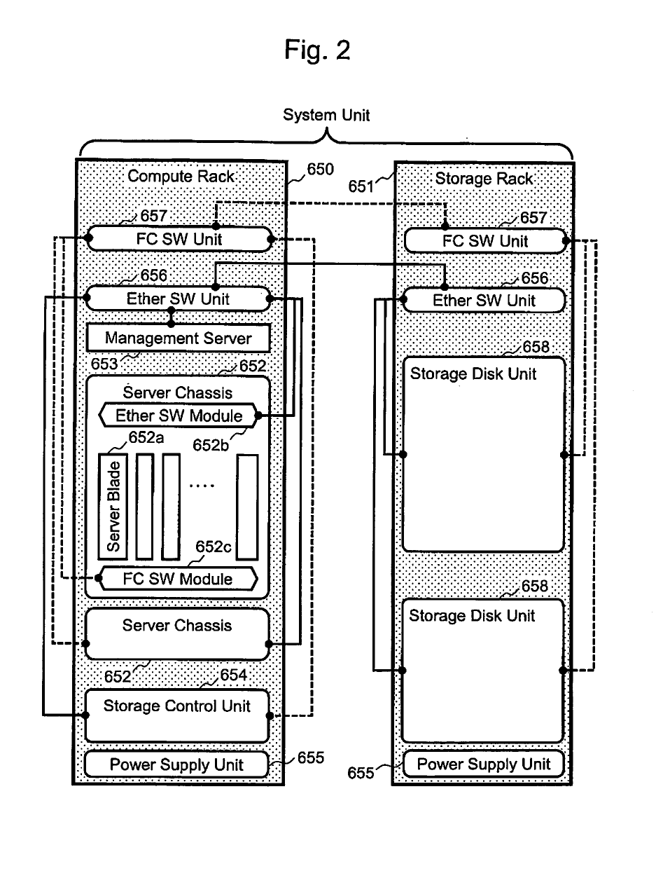

As described above, FIG. 1 illustrates a general physical configuration of a computer system according to an embodiment of the present invention, and the arrangement of the physical device is specifically as in FIG. 2, for example. FIG. 2 is a diagram illustrating physical arrangement in which each device constituting the computer system illustrated in FIG. 1 is mounted on a rack and their network connections and constitutes one system unit as a whole. The system unit is a basic unit of operation management, and a data center can be constructed by combining a plurality of the system units as necessary. Nowadays, a large number of devices are installed in a data center, and the system unit is an important concept for arranging, connecting and managing the devices in order. The system unit in this embodiment is composed of a calculation rack 650 and a storage rack 651. The numbers of the calculation rack 650 and the storage rack 651 are not necessarily one as in FIG. 2 but may be plural in accordance with a required resource amount. However, a management server 653 mounted in the calculation rack 650 needs to be constituted so as to handle one system unit as a whole as a management target.

On the calculation rack 650, a server device (a server chassis 652) mainly for operating an instance and a management device (a management server 653) for controlling each device are mounted. In an example in FIG. 2, a blade-type server device is mounted, and an instance is operated on a server blade 652a mounted on the server chassis 652. These server devices are not limited to those having the same configuration but several types may be present in the system unit. On the server chassis 652, devices modularized into an Ethernet switch module 652b, a fiber channel switch 652c and the like are mounted. On the calculation rack 650, the management server 653 for managing devices included in the system unit and a storage control unit 654 for controlling the storage apparatus in a centralized manner are mounted. Moreover, an Ether switch unit 656 collecting Ethernet switches for connecting the devices to each other and a fiber channel switch unit 657 collecting fiber channel switches are mounted. In addition, a power supply unit 655 for supplying power to each device in the rack is mounted.

On the other hand, on the storage rack 651, a storage disk unit 658 mainly integrating physical storage devices (HDD 101, for example) is mounted. The storage disk unit 658 realizes a function of providing a storage resource together with the storage control unit 654. The storage disk unit 658 and the storage control unit 654 may be mounted on separate racks as illustrated in FIG. 2 or may be installed across a plurality of storage racks in accordance with required capacity and performances. In the storage rack 651, too, the Ether switch unit 656 and the fiber channel switch unit 657 are mounted and play a role of connecting the devices in the rack and a role of connecting them to another rack. In addition, the power supply unit 655 for supplying power to each device in the rack is mounted.

Each of the above-described physical devices is configured to be fixed in the system unit and network wiring connecting the devices to each other is closed in the system unit and is not changed in principle. However, in case of necessity of linkage among a plurality of system units such as migration of an instance to another system unit, an inter-system-unit communication path is installed between the network switches. However, the devices in one system unit is not directly connected to the device in another system unit or managed by the management server 653 in another system unit in principle. There are some exceptions such as replacement of a device in case of a physical failure, for example, or a migration work caused by a device renewal, but execution of the operation management is usually closed in a system unit.

The management server 653 holds physical configuration information for a single system unit as a whole. This is equal to holding of physical path information. For example, if a calculation rack number of the server blade 652a is known, the storage disk unit 658 at the connection destination can be easily specified by examining the storage rack number in the same system unit. The servers sharing the same chassis number or rack number are physically located close to each other, and the latency (delay) can be small. As described above, since the physical configuration in the system unit is fixed in principle, the connection configuration can be grasped permanently by examining the device configuration at initial introduction or device renewal. For example, special analyzing means such as introduction of a configuration management agent into the hypervisor or OS and a periodical gathering of configuration information is not needed.

### Logical Configuration of Computer System and Creation Procedure of Instance

(i) Logical Configuration

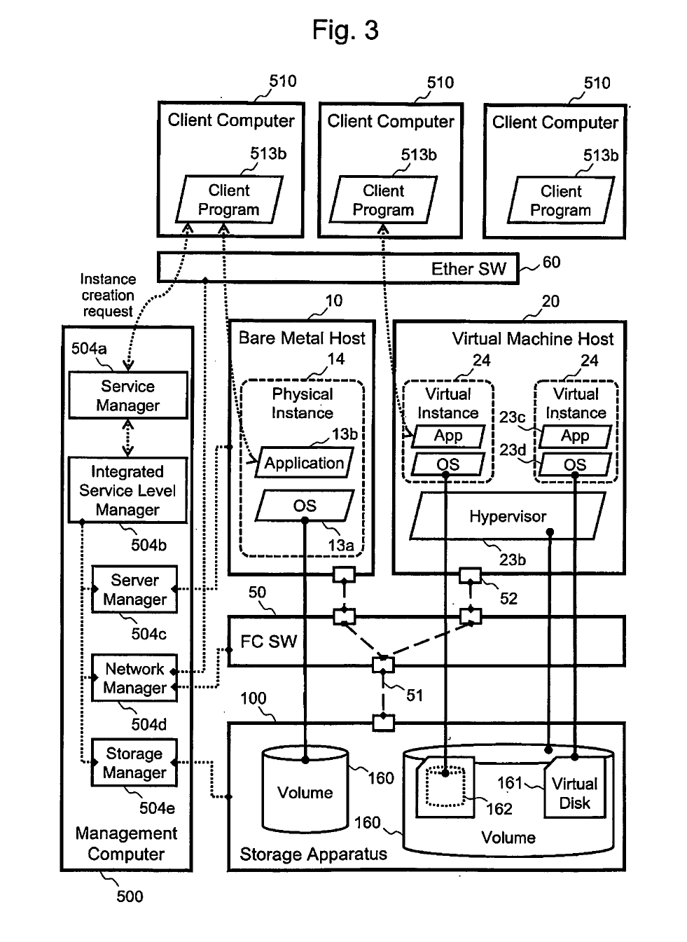

FIG. 3 is a diagram illustrating a logical configuration of a computer system according to the embodiment of the present invention. In FIG. 3, a scene in which a user creates a new server during system operation is assumed.

In FIG. 3, the applications 13b and 23c used by the user communicate with the client program 513b on the client computer 510 via the network 61 and provide a business service. The application is on the OS 13a directly operating on the hardware in the case of the bare metal server 10 or on the OS 23d operating further inside a virtual machine operating on the hypervisor 23b in the case of the virtual machine host 20. A resource region which is a logical server unit and into which an application and an OS can be introduced will be referred to as an instance below. Particularly, if it is on a bare metal server, it is called a physical instance and if it is on the virtual machine host 20, it is called a virtual instance. In this embodiment, the user creates a desired instance, changes its configuration, and constructs a targeted business system by introducing a desired OS and applications.

A storage resource used by each instance is provided by the storage apparatus 100. As illustrated in FIG. 3, in the case of a physical instance it is provided by a unit called a volume 160 in the storage apparatus 100. The volume 160 is recognized by the OS 13a of a physical instance 14 as one physical disk drive. In the case of a virtual instance, the hypervisor 23b creates a virtual disk 161 in a file format in the connected volume 160 and connects to a virtual instance. Moreover, the hypervisor 23b defines a virtual volume 162 in the virtual disk 161, and the virtual volume 162 is recognized by the OS 23d of the virtual instance 24 as a physical disk drive. Moreover, an owner is set for the virtual instance, and the applicable virtual instance can be used from any client computer as long as the owner is the same.

A connection path between the physical instance 14 and the volume 160 or a connection path between the hypervisor 23b and the volume 160 is set by the OS 13a and the hypervisor 23b. However, setting of the connection paths are possible only within a range in which a communication path is constituted by a physical connection and a logical connection of the network 51. The physical connection is made by connecting a port 52 on the FC IF provided in a device participating in the network by the fiber channel cable. The logical connection includes two settings, that is, setting in the FC SW 50 and setting in the storage apparatus 100. In the FC SW 50, a technology called zoning is used, and a method of setting a set of ports on a communicable switch and a method of setting a communicable node by an identifier (WWN) of the port 52 are provided. On the other hand, in the storage apparatus 100, a method of setting a port on the storage control portion 150 which can access the volume 160 and a method of setting a WWN in a physical server communicable with the applicable storage-side port are provided. The setting of the FC SW 50 and configurations of the storage apparatus 100 are managed/controlled by each device management portion which will be described later.

Moreover, FIG. 3 illustrates details of the management program 503b (see FIG. 1) operating on the management computer 500. In this embodiment, the type of the management program 503b is as follows. That is, the management computer 500 is provided with a service management portion 504a for receiving requests from the client computer 510, an integrated service level management portion 504b provided with a function relating to maintenance/change of the service level, a server management portion 504c for managing each device under control of the integrated service level management portion 504b, a network management portion 504d, and a storage management portion 504e. Each of these management portions 504a to 504e is composed of programs. The service management portion 504a receives a request of a user from the client computer and performs creation and configuration change of an instance. The integrated service level management portion 504b plays a role of maintaining a level of performances and a quality of the resource assigned to the instance in accordance with the request received from the service management portion 504a (if performances deteriorate, the portion executes expansion of the resource or migration of the server and if a load decreases and the use efficiency lowers, the portion reduces the configuration of an instance with low use efficiency). Processing for individual configuration change by actually connecting the device and the physical server and the storage apparatus directly is executed by the server management portion 504c, the network management portion 504d, and the storage management portion 504e. They are collectively called a device management portion for convenience. These device management portions control the devices to be managed by obtaining and changing the logical configuration information of the device. In this embodiment, these device management portions cannot grasp the configuration of a different device via communication with each other, and linkage between different types of devices is realized only by the integrated service level management portion 504b positioned at top of each device management portion. In this embodiment, a configuration change (expansion, migration, reduction) of an instance is executed upon an instruction of the user, but it may be so configured that if a performance quality of a resource assigned to an instance exceeds a predetermined threshold value, the configuration of the instance is automatically changed so as to maintain the performances and the quality level.

(ii) Instance Creation by Self-Service

As a specific example for explaining functions of each of the above-described configurations, a procedure for creating a (virtual) instance in the configuration according to this embodiment will be described. The procedure and technology for creating an instance explained here are known.

A user operates the client program 513b on the client computer 510 and accesses the management computer 500. The service management portion 504a on the management computer 500 authenticates that the user is authorized to create an instance by using identification information such as a user name, a password and the like. In general, a user is associated with a group account of an organization to which the user belongs, and the number of instances that can be created and a resource amount and physical devices that can be assigned are determined in advance for each group.

When the authority of the user is authenticated, the service management portion 504a presents one or more catalogs which become a model for an instance to the user. The catalog describes details of a CPU, a RAM, a network adapter, a disk capacity, a configuration of the OS, management functions such as highly usable options to be applied and the like. The user selects a desired one from the presented catalogs and requests the service management portion 504a to create the instance from the selected catalog. If necessary, the user requests a configuration described in the catalog with partial change (customization) within a range of the service level allowed by the service management portion 504a.

When the service management portion 504a receives a request for creating an instance from the user through the client program 513b, the service management portion executes instance creation processing. The instance creation processing includes procedures such as determination of a physical server/volume as an arrangement destination, creation of a virtual resource, copying of an OS image and the like. The determination of the physical server/volume at an arrangement destination is made considering a free space in the resource at the arrangement destination and other configuration change tasks. Since configuration changes across plural types of devices such as physical connection or mounting of the physical volume 160 have been performed in advance, when an instance is to be created, only a configuration change function of the hypervisor 23b such as creation of a configuration management file and creation of a virtual disk file at the most is used. In the virtual disks used by the instance, particularly for the OS region, there is a technology in which a virtual disk (OS image) in which a reusable OS has been set up is prepared so that installation of the OS is made unnecessary by logically copying the OS image when creating the instance.

When the creation of the instance is completed, the service management portion 504a notifies the user that the instance is in a usable state. After that, the user transfers an installer of a desired application (ISO disk image and the like) to the instance and can start construction of the business system.

### Change of Service Level

The present invention was made by paying attention to a change of a service level particularly in management of a resource to be assigned to an instance. By this embodiment, a system which presents a candidate of an appropriate migration measure is provided to a configuration change request by a user.

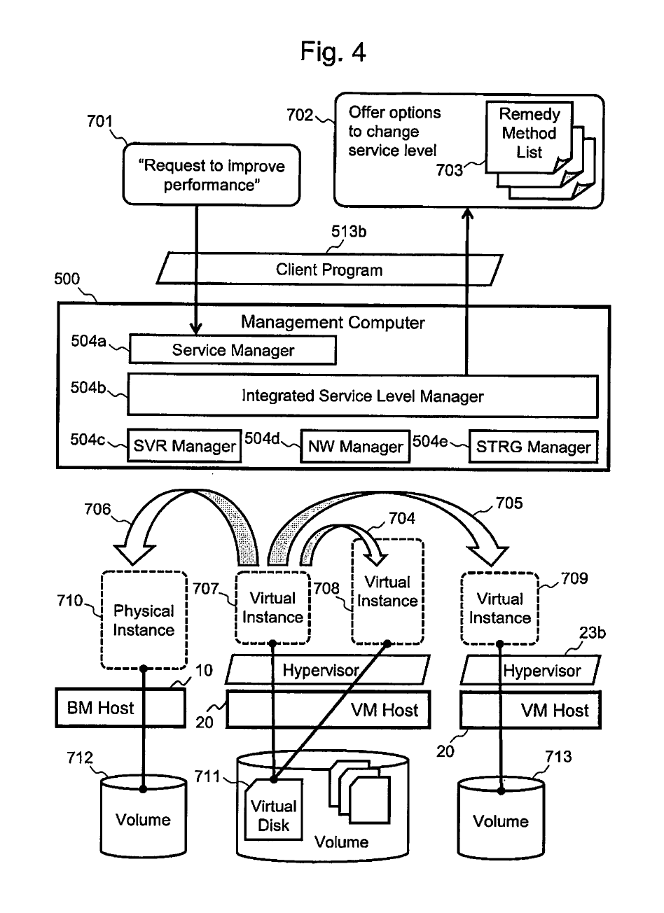

FIG. 4 is a diagram illustrating a concept of the function provided in this embodiment of the preset invention. For example, it is assumed that a virtual instance 707 is used, and the performance of the instance deteriorates. In an environment where the virtual machine host and the bare metal server are mixed, as measures for improving the processing performance of the virtual instance 707, mainly the following three measures can be considered.

A first measure is a scale-up 704 for increasing a resource assigned amount on the same virtual machine host 20 and can be taken relatively easily if there is a free resource in the virtual machine host 20. However, if there is a performance influence from another virtual instance on the same virtual machine host, the performance cannot be improved.

A second measure is a V2V migration 705 for migrating the virtual instance 707 to another virtual machine host and is effective if there is a performance influence on a calculation resource from another virtual server in the virtual machine host at a migration source. In the case of a performance influence on a disk IO, conversion of a virtual disk 711 to a volume 713 is likely to improve the performance. However, if there is another virtual instance having a similar load tendency in the virtual machine host at the migration destination, it is concerned that the performance is not improved even if the V2V migration 705 is executed. Moreover, if the performance influence on the disk IO is not significant in actuality, even if the virtual disk 711 is converted to the volume 713, the performance deterioration is not solved.

A third measure is a V2P migration 706 for migrating the virtual instance 707 onto the bare metal server 10 and converting it to a physical instance 710. By means of this V2P migration 706, a performance influence of another instance can be eliminated, and stable operation of the instance can be realized. However, the V2P migration generally has disadvantages that required time is long, OS needs to shut down and the like.

Since the user cannot grasp physical arrangement of the virtual instance or a processing load tendency of another virtual instance, the user cannot grasp a factor of the performance deterioration. Moreover, the user can make an access to the management computer 500, respectively, and can create/change a configuration of the instance by self-service by accessing the management computer 500, respectively, and it is performed asynchronously with operations of other users or the administrator side. Thus, if a user changes a configuration for performance improvement and further performs an operation which affects another instance, close adjustment with other users or the administrator is needed and cannot be performed immediately. If a change of the logical configuration of the system is frequently made, the configuration has been changed in a period from issuance of a request of performance improvement to migration, and the migration might fail. Furthermore, there is a trade-off in each of the migration measures as described above, and there are concerns not only that the user erroneously selects a measure that cannot solve the performance deterioration but also the user needs to pay a useless cost.

According to the present invention, a system that appropriately determines the factor of the performance influence that the user cannot know and presents a migration measure suitable for solving that is provided. That is, in FIG. 4, this computer system provides an integrated service level management portion 504b which, when the user issues a performance improvement request 701 of the instance to the management computer 500, calculates an appropriate migration measure (referred also as “improvement measure” hereinafter) 702 by referring to the configuration of the device and the performance history and presents it to the user.

### Migration Measure List

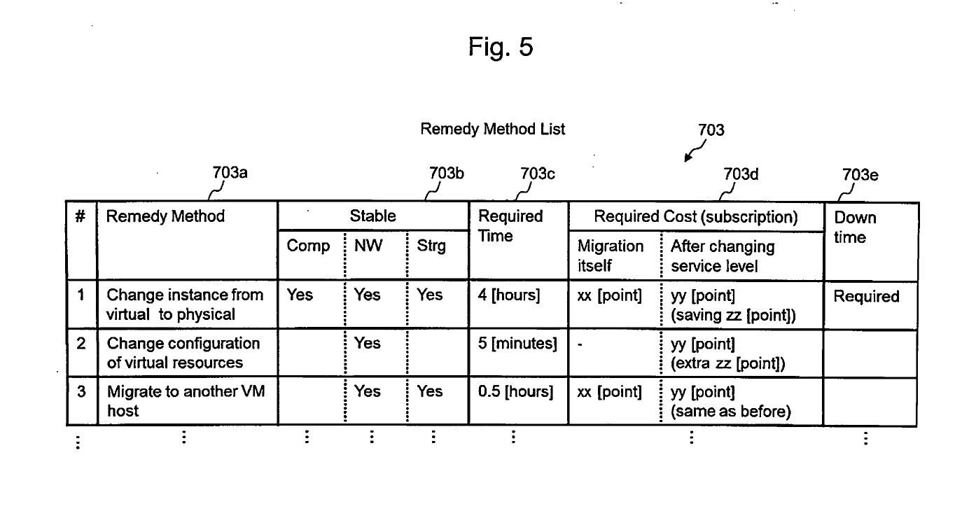

FIG. 5 is a diagram illustrating a migration measure list (referred also as “improvement measure list” hereinafter) 703 which is a specific format for presenting the migration measure 702 in this embodiment. In the migration measure list 703, one row indicates one migration measure.

The migration measure list 703 holds values for performance stability 703b, required time 703c, a required cost 703d, and a down time 703e for each migration measure 703a. In this embodiment, it is assumed that the user selects the desired migration measure 703a, and superiority of each migration measure 703a does not necessarily have to be considered. Therefore, the migration measures 703a may be stored in the migration measure list 703 simply in order of detection in a processing flow which will be described later. On the other hand, if it is advantageous for the user or if the migration measures are automatically narrowed to a certain number under a migration policy determined as important by the user, the superiority in the migration measures 703a may be indicated in the storage order in the list 703. As a method of determining such order, for example, the migration measures may be arranged in order from the highest degree of recommendation which will be described later or may be arranged in order from that with the largest number of items satisfying the migration policy.

The migration stability 703b is evaluated in three items, that is, a calculation resource, a network resource, and a storage resource, for example, and “Yes” is described if it is guaranteed that no performance influence is given from another instance. The state where no performance influence is given from another instance here means that a target instance occupies a physical constituent element (one processor, a port or a storage region, for example) on one device and does not share it with another instance. Stability of the calculation resource means that a resource can be sufficiently ensured. The network stability means that no bottleneck is generated. The storage stability means that IOPS is at a predetermined value or less (favorable). Those physical constituent elements on the device will be referred to simply as devices below for convenience. The items in which the device is not shared with another instance as the result of migration or no performance influence is generated at the time before migration do not cause a problem immediately after the migration, but since the performance might become unstable after migration, it is not considered as performance stability and nothing is described. Therefore, the items in which “Yes (Stable)” is not described indicates that the effect by the migration is lower than the case of “Yes (Stable)”. Even if “Yes” is not described, it does not mean that the specification requested by the user is not satisfied but it means only that the stability is not guaranteed (it is likely to be influenced by another instance), and the stability is higher than the current specification.

The required time 703c holds time required for performance of the migration measure.

The required cost 703d holds a cost for the migration work itself and a usual operation cost after the migration. The required cost needs to be calculated in compliance with a calculation formula realized by an accounting system. The down time 703e holds whether or not the OS on the instance needs to be shut down in the migration method. The user uses the application on the instance, and if the OS needs to be shut down in migration, interruption of the work by the application or data storage becomes necessary, and it is important to present this item to the user.

From FIG. 5, the migration measure #1 is the best choice, considering stability. Since the required time for migration is long for the migration measure #1, the migration measure #1 can be selected if there is sufficient time for the migration. However, if the user cannot stop the target virtual server for a long time, for example, the migration measure #2 might be selected even if the calculation resource or the like is somewhat insufficient and stability is not guaranteed. That is, the user can select the best measure as appropriate in accordance with the operation situation from the migration measures presented in the list.

### Functional Configuration of Management Program

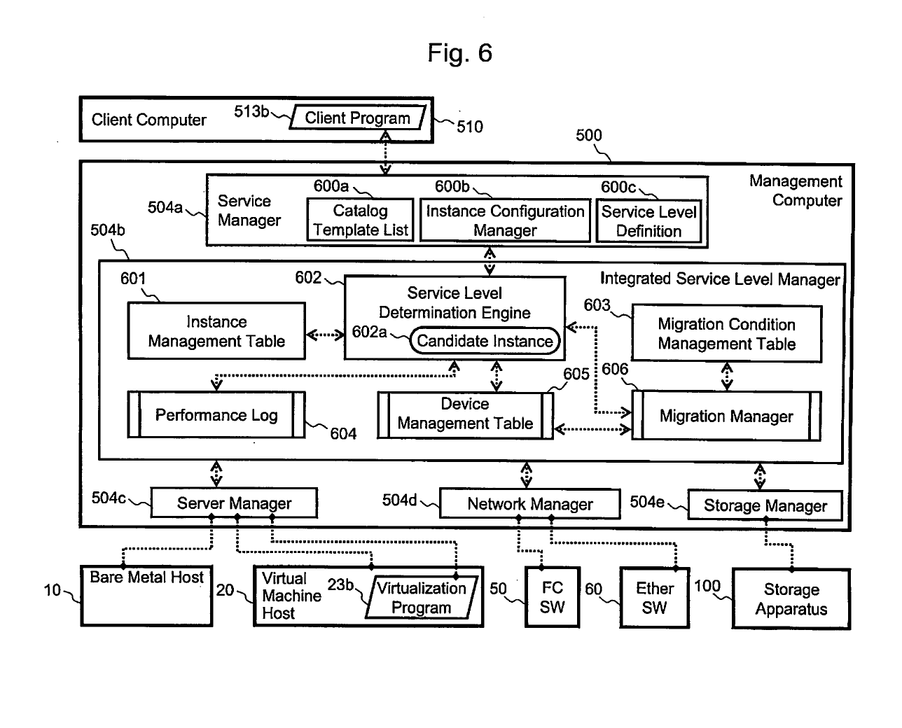

FIG. 6 is a diagram illustrating details of a management program group 503b operating on the management computer 500 and providing characteristic functions of the present invention. The management computer 500 has the service management portion 504a, the integrated service level management portion 504b, the server management portion 504c, the network management portion 504d, and the storage management portion 504e as management programs. The configuration and function of each portion will be described below.

(i) The service management portion 504a has at least a catalog template list 600a, an instance configuration management portion 600b, and a service level definition portion 600c.

The catalog template list 600a holds a list of catalogs so as to be referred to as a model when an instance is to be created. Items of the configuration information included in the catalog are selected from the items held in an instance management table 601 which will be described later. Therefore, items other than those held in the instance management table 601 are not included in the catalog but even if there are many, they are the same as those in the table. The catalog further holds a usage cost for each item of the configuration information. The values of these usage costs are calculated by the service management portion 504a on the basis only of the resource amount to be assigned and presence of the management functions.

The instance configuration management portion 600b creates and applies an instance configuration in accordance with the matters described in the catalog and the user's customization request. The configuration information of the instance is held in the instance management table 601 which will be described later. For example, if an inquiry is made about the configuration of the instance currently in use, the instance configuration management portion 600b obtains the applicable information from the instance management table 601 which will be described later and notifies it to the user.

The service level definition portion 600c holds the range and items capable of being customized. More specifically, the portion provides a function of determining an assignment ratio among SSD media and SAS HDD media and the like in a storage layer with the highest reading/writing performances in the options. For example, three-layered service levels such as gold, silver, and bronze can be defined and used in accordance with needs and situations.

(ii) The integrated service level management portion 504b has the instance management table 601, a service level determination portion 602, a migration condition management table 603, a performance history storage portion 604, a device management table 605, and a migration management portion 606. Among them, the performance history storage portion 604, the device management table 605, and the migration management portion 606 can refer to the device management portion (the server management portion 504c, the network management portion 504d, and the storage management portion 504e) or can set the device configuration.

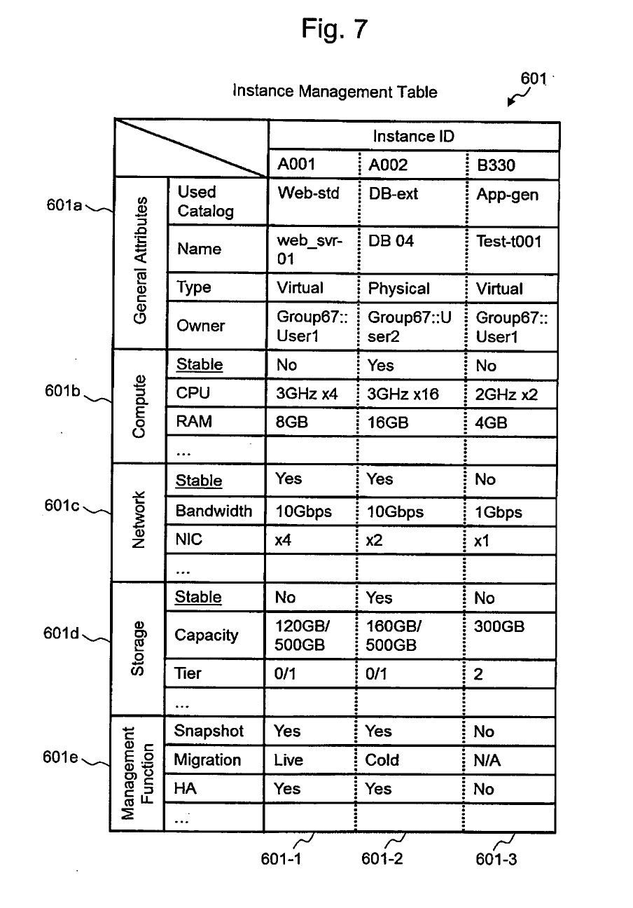

Details of the instance management table 601 are illustrated in FIG. 7. The instance management table 601 holds set values of each of a basic attribute 601a, a calculation resource 601b to be assigned, a network resource 601c, and a storage resource 601d and a set value of a management function 601e for each instance (instance in operation). This figure indicates that the instance management table 601 holds information for three instances of instances 601-1 to 601-3. The instance is identified by a unique identifier without duplication. In the basic attribute 601a, management information given to each instance such as the name of the instance, a catalog used as a creation source, a user of the instance and the like is described. It is only necessary that the name of the instance is a character string which can be easily understood by a user but shall be unique at least in an instance of the same user. A tag indicating an application of the instance, information such as time and date of creation and the like may be included if necessary. In the calculation resource 601b, attributes of the resource relating to calculation performances such as the CPU and the RAM and their assigned amounts are described. Similarly, in the network resource 601c, the attributes relating to the Ether network and the fiber channel network, and in the storage resource 601d, the attributes relating to the disk and the assigned amounts are described.

Moreover, the instance management table 601 has items indicating stability for each resource (underlined part in FIG. 7), and this is an important set value determining the service level in the present invention. If “No” is described in the item of the stability, it indicates that migration is preferably executed since the performances are likely to deteriorate due to competition with another instance.

Moreover, the management function 601e describes the items activated for each instance and their types. The items that can be described as the management function 601e are defined by the service level definition portion 600c and based on the function of the device management portions under control of the integrated service level management portion 504b and each device. In FIG. 7, the term “Cold” indicates that the instance needs to be stopped.

Returning to FIG. 6, the service level determination portion 602 receives a configuration change request from the user and determines which instance is affected by the performances and which instance is not affected by the performances. Then, the service level determination portion 602 calculates a migration measure for selecting a device as an appropriate migration destination candidate and the instance candidate 602a. The instance candidate 602a included in the service level determination portion 602 is an instance configuration after the migration provisionally assumed for verification of the migration measure and is expressed by the same items as those in the instance management table 601. The performance information to be the basis for examination of the migration measure is provided by the performance history storage portion 604. Moreover, a factor of the performance influence is identified and the calculated migration measure is specified to the migration management portion 606.

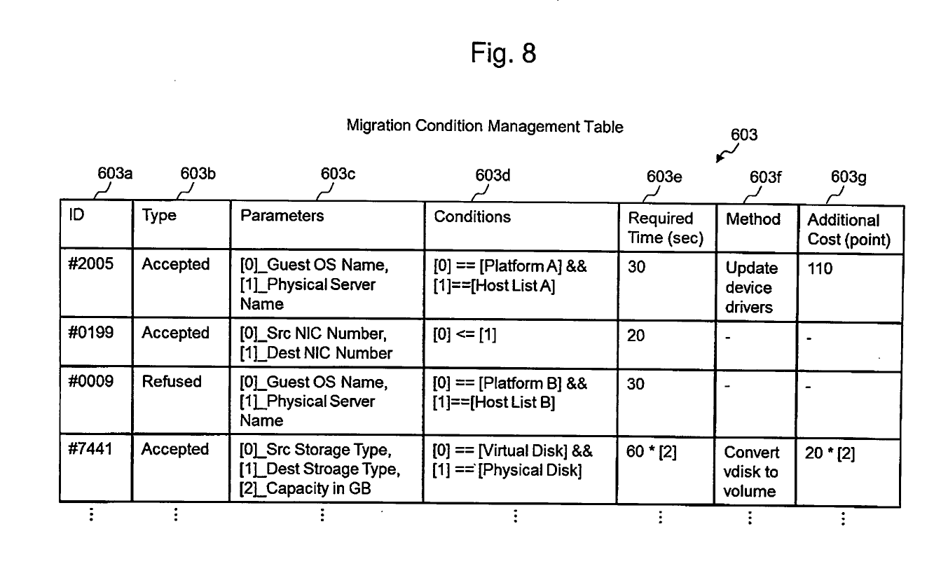

Details of the migration condition management table 603 are illustrated in FIG. 8. The migration condition management table 603 enumerates conditions relating to the migration of a constituent element, and all the conditions are evaluated by the migration management portion 606 for each instance candidate. The migration condition management table 603 illustrated in FIG. 8 is referred to in all the cases including migration from a virtual instance to a virtual instance, migration from a virtual instance to a physical instance, migration from a physical instance to a virtual instance, and migration from a physical instance to a physical instance. Here, the conditions relating to the migration of the constituent element are conditions imposed to software components and hardware devices constituting the instance, and standards for determining availability of migration and procedures (migration methods) required for the migration are made into logical forms. Specifically, it means that “if a physical instance operating on a bare metal server of a model A is to be migrated to a bare metal server of a model B, introduction of a driver of a device C is required” or that “a virtual instance in which the type of a guest OS is D, migration to a hypervisor E is not possible”. These conditions are determined by a management policy of the computer system or operation requirements of a migration tool to be used. However, these conditions are limited to those that should be expressed by values that can be observed by the management computer 500 and can be logically evaluated such as matching/non-matching, magnitude of a value, a range and the like.

The migration condition management table 603 holds a migration condition ID 603a, a type 603b indicating an output value when the condition 603d is matched, a parameter 603c determining a migration method 603f, a conditional expression 603d to which the parameter 603c is applied, an attribute (Type) 603b when the conditional expression 603d is true, a required time 603e taken for execution of the migration method, and a cost 603g required when the migration method is executed as configuration items.

Pairs of configurations, each specified as a pair of a migration source and a migration destination, include those capable of migration if the conditional expression 603d is true (Accepted) and those incapable of migration (Refused), and the attribute (Type) 603b indicates the acceptability. If the migration measure includes even one parameter determined to be incapable of migration (Refused), the conditional expression 603d in which the attribute (Type) 603b is incapable of migration holds true, and the migration measure is dismissed. However, even if the condition of the Accepted is not met, the target migration measure is not dismissed immediately. If the parameter 603c meets the condition 603d when the attribute (Type) is Accepted, the measure 603f is executed. For example, assume that, in the case of ID 603a=#2005, a guest OS name of an instance candidate of the processing target is X and a VM host (physical server) name is Y. At this time, it is determined whether these parameters meet the applicable conditions. In the case of this example, if the guest OS (X) is Platform_A and the VM host (Y) is HosetList_A, the attribute (Type) becomes “Accepted”, and the work indicated by the migration method 603f is executed.

The migration condition management table 603 may be realized as a collection of shell scripts or programs, not limited to the table format, as long as an evaluation method of the conditional expression 603d and a behavior with respect to its result can be described. The migration management portion 606 evaluates a migration source configuration and a configuration of a migration destination candidate calculated from the migration measure from the migration condition management table 603, and it is determined whether or not the migration measure can be executed. If the migration measure can be executed, the required time and cost taken for the migration are further calculated by evaluating the same migration condition management table 603.

Returning to FIG. 6, the performance history storage portion 604 obtains performance history relating to the resource of each device from the server management portion 504c, the network management portion 504d, and the storage management portion 504e and accumulates it in the memory, not shown. The performance information held by the performance history storage portion 604 is mainly composed of use rate (ratio of use time, the number of operations with respect to the total resource amount or use rate of a bus band) in each resource (CPU, RAM, network adapter, disk device), a waiting job length (the number of average waiting jobs to the queue whole length or an average buffer use amount), a command processed amount per unit time (IOPS and TPS: Transaction Per Second), average response time and the like. If a processing load deriving from a plurality of instances is generated, it is assumed to be able to be resolved to a load for instance only in the case of information that can be obtained from the OS and the hypervisor on each instance. However, the details of the items obtained by the performance history storage portion 604 and a target period for the history to be accumulated may be different depending on a determination algorithm of the service level determination portion 602.

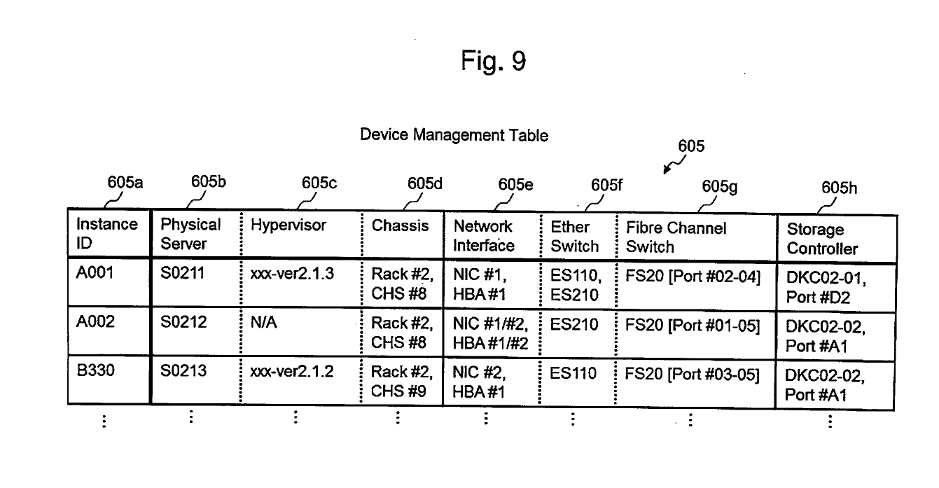

Details of the device management table 605 are illustrated in FIG. 9. The device management table 605 holds an identifier 605a for each instance, an operating physical server 605b, a hypervisor 605c (in the case of a virtual instance), a server chassis 605d on which the physical server is mounted, a network interface 605e, an Ether switch 605f at a connection destination acquired from a connection configuration of the system unit, a fiber channel 605g, and configuration information about a storage control portion 605h as management items. The configuration information can be obtained from each device management portion similarly to the case of the performance history storage portion 604.

For example, instances A001 and A002 share the server chassis. Instances A002 and B330 share a disk controller, and it is known that competition is likely to occur here.

As described above, by referring to the device management table 605, devices shared by instances can be checked.

### Processing for Calculating Migration Measure

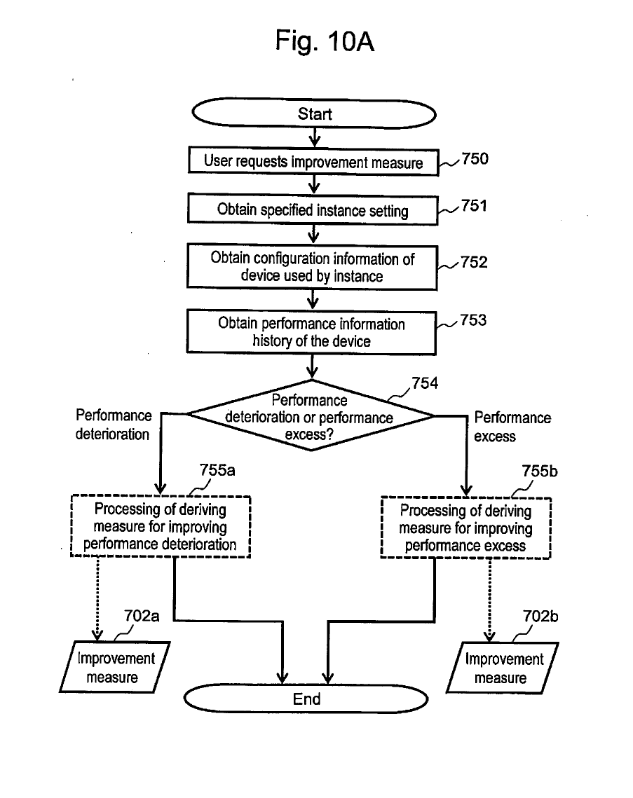

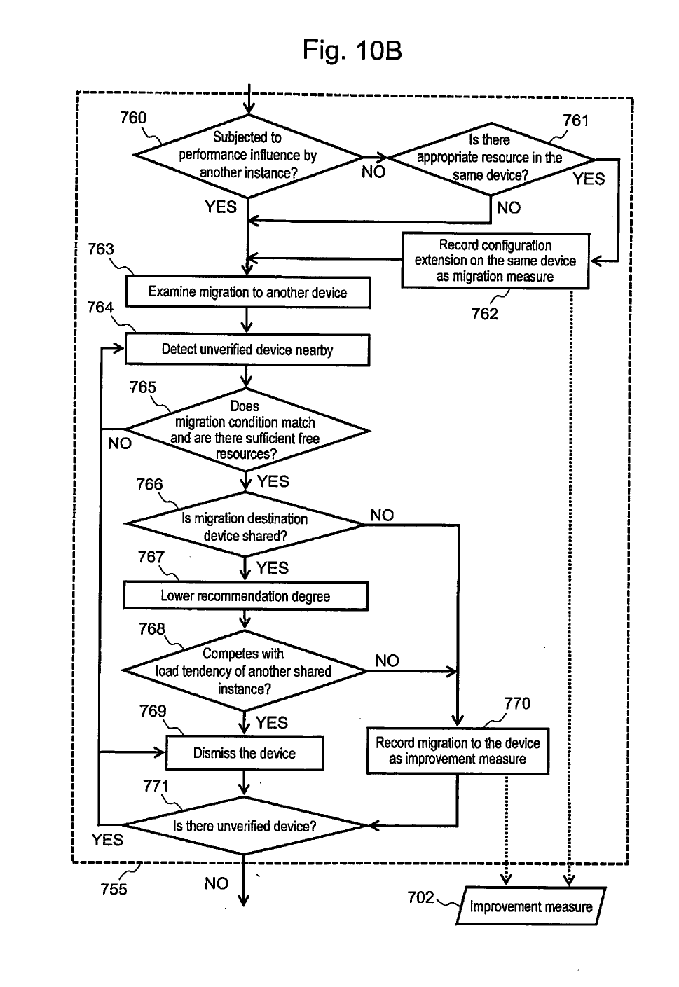

Processing for calculating a measure for improving performance deterioration and performance excess of instances will be described below. FIGS. 10A and 10B are flowcharts for explaining details of processing when a migration measure for improving performance deterioration of a virtual instance and a physical instance is to be calculated. In this processing, particularly the integrated service level management portion 504b has an important role and calculates the migration measure 702 in a format of a migration measure list 703. The integrated service level management portion 504b has degrees of recommendation of the migration measures therein, which may be used when priority of each migration measure 703a to be stored in the migration measure list 703 is indicated as described above.

At Step 750, the user requests a configuration change of the instance 24 from the service management portion 504a on the management computer 500 by using the client program 513b on the client computer 510. At this time, upon reception of the request from the user, the client program 513b notifies the name of the virtual instance (see 601a in FIG. 7) to the service management portion 504a. In the background, there is a trigger that the user felt performance deterioration in the application 23c on the virtual instance 24. However, the user himself/herself does not determine what the main factor for the performance deterioration is.

At Step 751, the service management portion 504a accepts the configuration change request on the basis of the access authority of the user and notifies the instance name specified by the user to the integrated service level management portion 504b. The integrated service level management portion 504b identifies an identifier of the instance described in the instance management table 601 by using the name of the instance received in the service level determination portion 602. If there are a plurality of names of the same instance, the identifier is identified in combination with other types of information such as identification by using the name of the user (user of the instance).

At Step 752, the service level determination portion 602 searches the device management table 605 by using the identifier of the instance identified at Step 751 and identifies the device (server device, network device, storage apparatus) used by the instance.

At Step 753, the service level determination portion 602 obtains history of performance information (there are various types of histories such as a history of one day, a history of a week and the like, for example) from the performance history storage portion 604 for all the devices identified at Step 752. As a result, other instances and devices that can give a performance influence to the instance are known.

At Step 754, the service level determination portion 602 branches the processing into processing for improving performance deterioration (Step 755a) or processing for improving performance excess (Step 755b) in accordance with the improvement request made by the user to the instance (instance being used by the user) or a change in the performance history of the instance. Here, if the user requests a measure for improving the performance deterioration at Step 750 or if an increase in the processing load of the instance is detected in the performance information history, for example, the processing proceeds to the processing 755a for deriving a measure for improving the performance deterioration. On the other hand, if the user requests a measure for reducing the configuration of the instance with performance excess at Step 750 or if the fact that the processing load of the instance is lower than an assigned resource is detected in the performance information history, the processing proceeds to the processing 755b for deriving a measure for improving the performance excess. The details of the processing 755a and 755b will be sequentially described below, and improvement measures 702a and 702b can be calculated by the processing.

(i) Performance Deterioration Improvement Measure Deriving Processing

The details of the processing 755a for deriving the measure for improving the performance deterioration will be described by using FIG. 10B.

At the above-described branching Step 754, if it is determined that performance is deteriorating, the processing proceeds to Step 760.

At Step 760, the service level determination portion 602 determines whether or not each device of the instance is subjected to a performance influence by another instance. More specifically, presence of performance influence to the calculation resource given by another virtual server using the same virtual machine host or presence of the performance influence to the network resource given by another physical server sharing the same network port is examined, and determination is made. The result of determination on presence of the performance influence is evaluated in the calculation resource, network resource, and storage resource and held in the instance management table 601. If it is determined at this Step that the performance influence by another instance is not a factor, the processing proceeds to Step 761. If it is determined that another instance gives a performance influence, since the extension of the configuration (resource addition) is not necessary, the same configuration as the migration target instance is set for the instance candidate 602a indicating the instance configuration after the migration, and the processing proceeds to Step 763.

At Step 761, the service level determination portion 602 obtains a free resource amount in the same device from the performance history storage portion 604 and determines whether or not there is a suitable resource (whether or not there is a sufficiently free resource). The free resource amount here means a usable resource amount if each device management portion discloses it and the amount obtained by subtracting a resource total amount in use from the total resource amount if it is not disclosed. Moreover, the service level determination portion 602 determines a resource amount to be extended and sets the instance candidate 602a. Methods for calculating a resource amount to be extended include a method of using a fixed ratio determined in advance (25% increase of an existing resource amount, for example), a method of adding an amount to lower the current use rate to a use rate of a certain period before, a method of making an inquiry with the user and the like. Moreover, the service level determination portion 602 compares the free resource amount with the resource amount to be extended and determines if the configuration extension is possible. If an upper limit value of the resource amount that can be assigned to one instance is set by the configuration of the device, comparison with the upper limit value is also made, and availability is determined. If it is determined that a free resource is sufficient, the processing proceeds to Step 762. If it is determined that the free resource is not sufficient, it is determined that migration to another device is necessary even if there is no performance influence from another instance, and the processing proceeds to Step 763. Moreover, if the instance occupies each device, or if it is the physical instance occupying one bare metal server, for example, it is highly likely that it is determined that there is no performance influence from another instance at Step 760. In that case, though the processing proceeds to Step 761, it is determined that there is no free resource at Step 761, and the processing proceeds to Step 763.

At Step 762, the service level determination portion 602 adds the configuration extension in the same device to the improvement measure list 703 and notifies it to the migration management portion 606. Particularly if the performance deteriorates since the virtual instance lacks in the calculation resource, for example, only the configuration change of the virtual instance in the same virtual machine host is made, and the possibility of execution of migration is not denied by the migration management portion 606. Therefore, the migration management portion 606 is used only for calculating required time and cost taken for the migration by the migration condition management table 603. Moreover, as integration of the numbers which become stable performance for each resource, the degree of recommendation is calculated. If it is concerned that the resource at the migration destination is consumed by another user or the administrator in a period until approval for the user requesting the performance improvement of the instance is obtained, a procedure for reserving the resource at the target migration destination may be further taken.

Step 763 and after are a flow for examining migration to another device. At Step 763, the service level determination portion 602 requests the migration management portion 606 to migrate the instance to another device different from that on which the virtual instance is currently operating. At this time, the migration management portion 606 examines not only the virtual machine host but also the bare metal server as the migration destination even if the migration destination is a virtual instance.

At Step 764, the migration management portion 606 detects a device arranged physically nearby, that is, a device mounted on the same rack with priority as a candidate for the migration destination. The nearer the device is, the shorter the time required for the configuration change can be. However, a device in another system unit is not chosen as a candidate for the migration destination.

The migration management portion 606 holds the candidates of the migration destination devices and a result of verified or not-verified of the candidates and executes Steps 765 to 771 for sequentially determining whether or not the device is suitable as a migration destination. If an appropriate device is not found in the same system unit, a migration destination device needs to be searched across the system units. When migration across the system units is to be executed, since the management computers 500 managing configuration are different, not only the configuration change of the device but also the management information needs to be migrated at the same time.

At Step 765, the migration management portion 606 refers to the device management table 605 and evaluates the conditions described in the migration condition management table 603. At this time, if at least one execution possibility of migration is denied, that is, if a conditional expression indicating that migration is not possible by the attribute (type) 603b holds true (in the case of Refused), the processing proceeds to Step 763. Moreover, if it is detected from the performance information held by the performance history storage portion 604 that there is no sufficient free resource in the migration destination device, too, the migration management portion 606 immediately regards it as inappropriate as a migration destination and the processing proceeds to Step 769. On the other hand, if the execution possibility of migration is not denied, and there is sufficient free resource, the processing proceeds to Step 766.

At Step 766, the migration management portion 606 examines if the migration destination device is shared by another instance or can be occupied in the case of migration. However, if the migration destination device is not used by another instance and occupation is allowed, the migration measure is considered to be appropriate, and the processing proceeds to Step 770. If it is likely to be influenced by another instance at the migration destination device, the processing proceeds to Step 767.

At Step 767, the migration management portion 606 lowers the recommendation degree of the migration measure. The recommendation degree is lowered at this Step because, though determination to dismiss the migration measure cannot be made, a measure to have the device occupied is superior in a point that stable operation can be realized since a possibility of performance influence remains.

At Step 768, if the other instances operating on the device to be verified indicate the same processing load tendency as the migration target instance, since a possibility of the performance influence is suggested, the migration management portion 606 determines that the device is not suitable as a migration destination and makes the processing proceed to Step 769. If the load tendency of the migration target instance does not compete with the load tendency of the other instances, it is determined to be a candidate for an appropriate migration destination device, and the processing proceeds to Step 770.

At Step 769, since it was determined at Step 768 that the device is not appropriate as a migration destination device, the migration management portion 606 dismisses the device from the migration destination candidates and excludes it from the subsequent verification candidates.

At Step 770, the migration management portion 606 adds the migration method in the improvement measure list 703 together with evaluation of the required time and cost taken for migration by referring to the migration condition management table 603. Similarly to Step 762, the recommendation degree is calculated, but if Step 767 is gone through, the recommendation degree lowered by one level is reflected for the resource. Moreover, if it is concerned that the migration destination resource of the target device is consumed by the other users and the administrator in a period until the approval of the user who requested the performance improvement of the instance is obtained, a procedure for reserving the resource at the target migration destination may be further taken. Moreover, the device is removed from the subsequent verification candidates.

At Step 771, the migration management portion 606 determines whether or not there is any unverified candidate in those held as verification candidates. If there are unverified candidates, the processing returns to Step 759 in order to select one of them and to apply the verification processing again, while if there is no unverified candidate (the remaining verification candidate is empty), this processing is finished. By going through this processing flow, the measure for solving the performance deterioration is stored in the improvement measure list 703.

(ii) Performance Excess Improvement Measure Derivation Processing

The above explanation describes calculation of a measure for improving performance deterioration of an instance, and calculation of a measure for improving performance excess of an instance will be also described similarly by using a processing flow illustrated in FIGS. 10A and 10B. Situations in which the performance excess can easily occur include a case where a device component such as a physical network port is occupied, a case where one physical server is occupied and the like, for example. Particularly, a physical instance is a bare metal server to which an abundant processing resource of a physical server is assigned exclusively, and if a processing demand for an application on the instance decreases, it is likely that resource use efficiency might lower. In this configuration, if a user feels such performance excess and determines that if the user continues using the instance, the cost will rise, a request to raise the management resource use efficiency is made to the management computer 500 by using the client program 513b. In response to the request, each component of the management program improves the resource use efficiency by reducing the resource amount assigned to the instance or by migrating it to another device with a smaller resource amount. Even in the case of performance excess if the user allows the performance influence and the same physical device is shared with other instances such as a case of a virtual instance which is a virtual server, not that the resource assignment amount is simply reduced but migration is performed while maintaining stable performance. At this time, determination needs to be made on whether or not the device is to be shared or a device with a smaller resource capacity is to be occupied by adding the influence of the performances. Particularly in the case of a physical instance (physical server), since configuration reduction by a resource assignment change cannot be made easily as the virtual server, calculation processing for an improvement measure is executed on the premise of migration. In the case of the physical instance, a physical instance or a virtual instance is selected as a migration destination where the configuration can be reduced, but since use of the physical instance itself indicates that the server stability is given priority, it is necessary to select a migration destination where reduction of the configuration is possible and also, stability of the operation is guaranteed (even in the case of a change from a physical instance to a virtual instance).

In the above-described processing for improving performance excess, Step 750 to Step 754 are applied in FIG. 10A, and at the branch at Step 754, processing proceeds to Step 755b for deriving a measure for improving performance excess. Details of the processing 755b will be described below, but an improvement measure 702b is calculated by this processing.

The details of the processing 755b for deriving the measure for improving performance excess will be also described by using FIG. 10B similarly to the processing 755a.

At Step 754, if it is determined that performance excess has occurred, the processing proceeds to Step 760.

At Step 760, the service level determination portion 602 determines whether or not each device of the instance is subjected to a performance influence by another instance. As compared with the above-described, in the case of the above-described performance deterioration, if the performance excess occurs, there is little possibility that the performance influence from another instance affects a performance upper limit of the instance, and Step 760 is executed in order to examine correlation of load tendencies. At this Step, if it is determined that the load tendency does not compete with the load tendency of another instance, the processing proceeds to Step 761. If it is determined that the load tendency competes with the load tendency of another instance, the processing proceeds to Step 763 in pursuit of another device more suitable for the required performance.

At Step 761, the service level determination portion 602 obtains a resource amount in the same device from the performance history storage portion 604. The service level determination portion 602 determines a resource amount to be reduced and sets the instance candidate 602a. The configuration of the instance candidate 602a is set in accordance with the processing demand, and a method of using a fixed ratio determined in advance (25% reduction of an existing resource amount, for example), a method of reducing a resource amount to raise the current use rate to a use rate in a certain period before, a method of making an inquiry with the user and the like can be used, for example. Moreover, the service level determination portion 602 compares the obtained resource amount of the same device with the resource amount of the instance candidate 602a and determines if the migration is possible. Particularly in the case of the performance excess in the calculation resource of a virtual instance, the configuration can be reduced without a problem in many cases, but in the case of a physical instance, the configuration change cannot be made physically such as the number of CPUs in many cases. Moreover, if a lower limit value of the resource amount that can be assigned to one instance is set for the configuration of a device, comparison is made with the lower limit value, and availability is determined. If it is determined that migration is possible, the processing proceeds to Step 762. If it is determined that migration is not possible, it is determined that migration to another device is necessary, and the processing proceeds to Step 763.

At Step 762, the service level determination portion 602 adds configuration reduction in the same device to the improvement measure list 703 and notifies it to the migration management portion 606.

Step 763 and after are processing for examining migration of an instance to another device.

At Step 763, the service level determination portion 602 requests the migration management portion 606 to migrate the instance to another device different from that on which the virtual instance is currently operating.

At Step 764, the migration management portion 606 responds to the request (instruction) from the service level determination portion 602, detects a device arranged physically nearby, that is, a device mounted on the same rack with priority as a candidate for the migration destination. The reasons why the device mounted on the same rack is given priority are as described above.

At Step 765, the migration management portion 606 refers to the device management table 605 and evaluates the conditions described in the migration condition management table 603. At this time, if feasibility of at least one migration is denied, that is, if a conditional expression indicating that migration is not possible by the attribute (Type) 603b holds true (if even one Refused is held), the processing proceeds to Step 763. If it is detected from the performance information held by the performance history storage portion 604 that the migration destination device does not have sufficient free resource, too, the migration management portion 606 immediately regards the device as inappropriate as a migration destination and the processing proceeds to Step 769. If feasibility of the migration is not denied and there is sufficient free resource, the processing proceeds to Step 766.

At Step 760, the migration management portion 606 examines if the migration destination device is shared by another instance or occupation is possible after migration. However, if the migration destination device is not used by another instance and occupation is allowed, it is assumed that the migration measure is applicable, and the processing proceeds to Step 770. If an influence is likely to be applied by another instance at the migration destination device, the processing proceeds to Step 767.

At Step 767, the migration management portion 606 lowers the recommendation degree of the migration measure.

At Step 768, if another instance operating on the verification target device shows the same processing load tendency as the migration target instance, since a possibility of a performance influence is suggested, the migration management portion 606 determines that the device is not appropriate as a migration destination and makes the processing proceed to Step 769. If the load tendency of the migration target instance does not compete with the load tendency of another instance, the migration management portion 606 determines that the device is an appropriate candidate for the migration destination device and makes the processing proceed to Step 770.

At Step 769, since it was determined at Step 768 that the device is not appropriate as a migration destination device, the migration management portion 606 dismisses the device from the migration destination candidates and excludes it from the subsequent verification candidates.

At Step 770, the migration management portion 606 adds the migration method in the improvement measure list 703 together with evaluation of required time and cost taken for the migration by referring to the migration condition management table 603. Moreover, the recommendation degree is calculated similarly to Step 762, but if Step 767 is gone through, the recommendation degree lowered by one level is reflected for the resource. Moreover, if it is concerned that the migration destination resource of the target device is consumed by the other users and the administrator in a period until the approval of the user who requested the performance improvement of the instance is obtained, a procedure for reserving the resource at the target migration destination may be further taken. Furthermore, the device is excluded from the subsequent verification candidates.

At Step 771, the migration management portion 606 determines whether or not there is any unverified candidate in those held as verification candidates. If there are unverified candidates, the processing returns to Step 759 in order to select one of them and to apply the verification processing again, while if there is no unverified candidate (the remaining verification candidate is empty), this processing is finished As described above, a measure for solving the performance excess is stored in the improvement measure list 703.

### Method for Identifying Performance Influence Factor

As described above, the factors of the performance deterioration of the instance include a case where the resource assigned amount is simply insufficient and a case where the processing demand is competing for the resource shared by another instance. In the case of the performance excess on the contrary, by means of migration so that the same device is shared by an instance with which the processing demand is not completing, improvement of the entire resource use rate can be expected. Here, a method of discriminating the influence factor which is indispensable in selecting an appropriate migration measure will be described. This is more specifically processing required at Step 760 and Step 768 in the processing flow (see FIGS. 10A and 10B) in this embodiment.

In order to determine whether or not another instance has an influence on the performance of the instance of an improvement target, first, it is necessary to examine which device is shared by another instance. This can be determined by referring to the device management table 605 (see FIG. 9), and it is only necessary to search a record including the same device for each device used by the improvement target. For example, it is known that the instance having an identifier “A002” shares a port #05 of a fiber channel switch FS20 and a port #A1 of a storage controller with an instance B330.

Subsequently, regarding the shared device, whether the instances influence each other or not is examined. Methods for examining it include at least the following three methods.

A first method is evaluation of correlation between a load change tendency deriving from an instance of an improvement target and a load change tendency deriving from another instance by referring to the performance history of the device from the performance history storage portion 604. If the change tendencies of the instance of the improvement target and another instance are opposite to each other, it is highly likely that the performance is influenced, while if there is no correlation, the possibility of performance influence is low. For example, if the performance of instance of the improvement target deteriorates while the performance of another instance is improved, it can be determined that the processing performance is deprived of by another instance. On the other hand, if the performance of another instance has not changed while the performance of the instance of the improvement target has deteriorated, it can be determined that resource supply is simply insufficient with respect to an increase in the processing demand in the instance.

A second method is to compare a recent history with a past history regarding loads deriving from the instance of the improvement target and another instance by referring to the performance history of the device from the performance history storage portion 604. If the performance of the improvement target is steadily deteriorating, while another is steadily rising in comparison with the performance history in a certain period in the past, a performance influence can be detected. If priority control is used in the disk IO or a network switch in the device, the performance of those with low priority might deteriorate in a long term as the result of change of setting of a control policy. Such control policy might be determined for applications of communication (whether or not the application requests data transmission/reception, whether or not to load data transfer/control information/program code and the like), and it is likely that the policy is not set for each instance. In such a case, the performance influence can be detected by examining the load tendency in a longer term.

A third method is to detect that the performance capacity of the device has reached a limit value by referring to the performance history from the performance history storage portion 604. If the device is shared by a plurality of instances, it is likely that the resource becomes insufficient due to the total sum of the loads, and this can be detected only after the loads of the entire device are grasped. Moreover, with this method, mutual performance influences can be detected even if marked correlation does not occur among the load tendencies of the plurality of instances due to an effect of an existing technology of passing on resources within the device such as swap of memory regions, buffering of transfer data in the network adapter, dynamic assignment of a CPU core and the like, for example.

The above-described methods are common in a point that determination is made on whether or not the performance influence has occurred between the plurality of instances by identifying the instance sharing the same device and by examining the tendencies of their respective processing loads. These determination methods are realized by the service level determination portion 602, and the performance history of each device can be obtained from the performance history storage portion 604. However, since the performance history that can be held by the performance history storage portion 604 is limited to the items that can be obtained from each device management portion, the service level determination portion 602 has a function of selecting a usable determination method on the basis of the performance items that can be obtained.

### Summary of First Embodiment

As configured as above, a system is provided that presents a migration measure suitable for improvement of performances if a configuration change of an instance is requested by being motivated by performance deterioration or performance excess of an application on the instance. According to the first embodiment, even if the user of an instance cannot know the device configuration and the connection configuration in which the instance is arranged, an appropriate migration measure is presented. The presented migration measure includes not only the type of the resource by which the performance is improved but also predicted value of required time and a cost incurred by the measure and a cost taken for the operation of the instance after migration. As a result, the user can quantitatively grasp merits and demerits of a plurality of presented migration measures and singularly select a migration measure, or a migration measure can be determined automatically on the basis of a policy set by the user.

### (2) Second Embodiment

A second embodiment is the same as the first embodiment in a point that it has a function of creating a migration measure for a configuration change of a user but is different from the first embodiment in a point that a proximate catalog is recommended as a migration measure.

As described above, the catalog is a typical configuration of a server designed by considering factors such as an application of the instance, sizing of a physical resource and the like. Therefore, if a configuration change extremely departing from the catalog configuration is made, it is concerned that the resource use rate lowers or software requirements of the application operating on the instance are no longer met.

More specifically, assume that only addition of a memory is made for performance improvement if a memory resource of a virtual instance is not insufficient, for example. At this time, it becomes likely that since the virtual instance consumes most of the memory resource of the physical server while the use rates of other resources such as CPU and NIC are low, another virtual instance cannot be created on the same physical server. In the case of an application having a sizing requirement that a corresponding network band needs to be added to a memory resource capacity, it is likely that the subsequent network communication becomes a bottleneck and processing performance might lower. At this time, by presenting a catalog designed for a physical server on which a large-capacity memory is mounted or a catalog in which the large-capacity memory and the network are sized for a specific application, the user can be induced to an instance configuration more suitable for the application of the instance and the entire system. Moreover, as a result of a catalog proposal as above, an advantage can be obtained that a more populous catalog can be grasped by means of statistics of a frequency that the catalog is selected. This is a useful advantage in a point that a ground for sizing can be obtained for an administrator who designs a catalog or an administrator who increases physical devices.

In the second embodiment, Step 761 and Step 765 including processing for calculating a candidate of a migration destination configuration is changed as compared with the first embodiment. At those Steps, particularly processing for searching a catalog which can be set as an instance candidate 602a is added. Moreover, the migration measure 702 presented to the user becomes a catalog list instead of the improvement measure list 703 illustrated in FIG. 5. The other physical configurations and logical configurations are the same as those in the first embodiment.

At Step 761, the instance candidate 602a provisionally holding an instance configuration after migration in the same device is set. At this time, a proximate catalog is searched, and the instance candidate 602a is updated by a set value described in the catalog. Such catalog will be called a recommended catalog below.

In this embodiment, the catalog for the virtual instances and the catalog for the physical instances are separately created mainly in accordance with the configuration of the server device. Therefore, at Step 764, if an unverified server device, not a storage apparatus or a network device, is selected, a catalog suitable for the configuration of the server device is selected again as a recommended catalog. More specifically, at Step 765, if it is determined that particularly a change from a virtual instance to a physical instance (V2P migration) or a change from a physical instance to a virtual instance (P2V migration) is necessary, a recommended catalog is searched again, the instance candidate 602a is updated, and the determination processing at Step 765 is executed again.

### Concept of Search Processing for Proximate Catalog

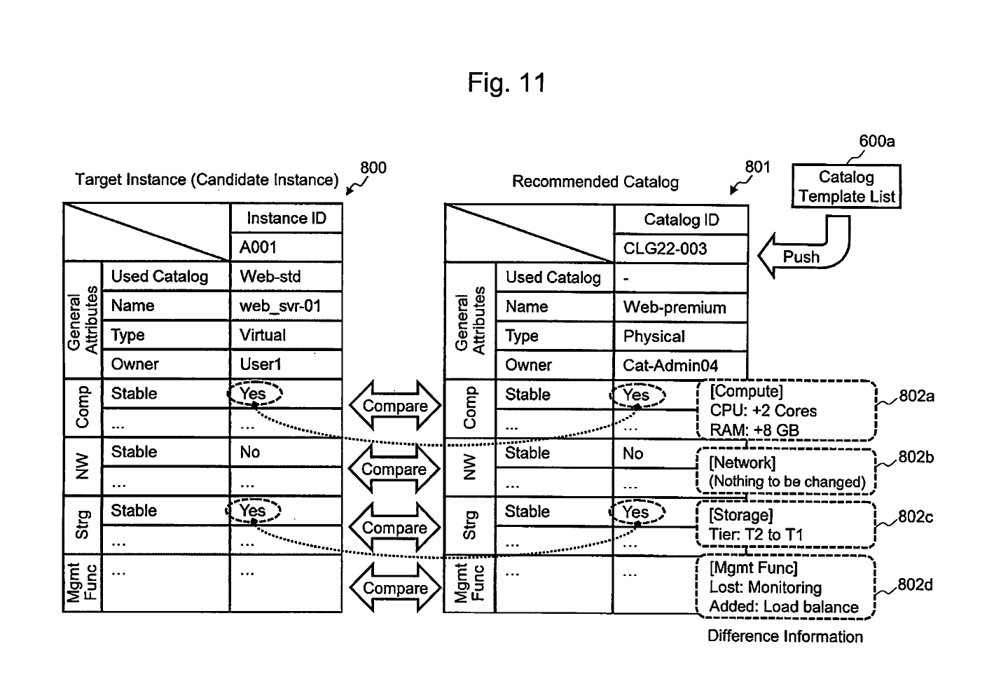

FIG. 11 is a diagram for explaining a concept of processing for searching a proximate catalog for an instance. Here, assume an instance configuration 800 to be evaluated as an example. As processing for searching a recommended catalog, the following two methods can be considered.

(i) First Method

A first method is based on a resource amount. This method is used mainly if it is determined that the instance candidate 602a before migration needs a configuration change.

The service level determination portion 602 determines a resource added amount (or a reduced amount) for the instance candidate 602a and sets it as an instance configuration to be evaluated and holds items requiring change.

Subsequently, the service level determination portion 602 sequentially obtains candidate catalogs 801 from the catalog template list 600a and calculates a difference amount by means of comparison for the items requiring change. Those with the difference amounts satisfying the desired change amount are chosen as recommended catalogs. For example, if at least 4 GB needs to be added to a memory, a catalog with at least 4 GB addition is selected as a candidate.

If such catalogs are selected in plural, the service level determination portion 602 may calculate a difference for other resource amounts and presence of a management function (difference information 802a-802d) and narrow the candidates to those with the minimum difference amounts.

Then, the service level determination portion 602 updates the instance candidate 602a with the recommended catalog and holds an identifier of the recommended catalog.

(ii) Second Method

A second method is based on performance stability of resources. This method is used mainly when it is determined that performance influence occurs on the instance candidate 602a before migration by another instance.

The service level determination portion 602 identifies a resource which should solve the performance influence and holds it for the instance candidate 602a.

Subsequently, the service level determination portion 602 sequentially obtains the candidate catalogs 801 from the catalog template list 600a and calculates a difference amount by means of comparison for the items requiring stabilization. For example, if it is calculated that the calculation resource and the storage resource require stabilization as in FIG. 11, a catalog which makes both the calculation resource and the storage resource stable is chosen as a recommended catalog.

If such catalogs are selected in plural, the service level determination portion 602 may calculate a difference for other resource amounts and presence of a management function and narrow the candidates to those with the minimum difference amounts.

Then, the service level determination portion 602 updates the instance candidate 602a with the recommended catalog and holds an identifier of the recommended catalog.

(iii) Presentation of Improvement Measure

After the processing for calculating the migration measure (the above-described (i) or (ii)) is completed, the service management portion 504a obtains information of the recommended catalog from the catalog template list 600a on the basis of the identifier of the recommended catalog held by the service level determination portion 602 and presents it as the improvement measure 702.

### Summary of Second Embodiment

As configured as above, a system is provided that presents a change destination catalog suitable for improvement of performances if a configuration change of an instance is requested by being motivated by performance deterioration of an application on the instance. According to this embodiment, the user can construct a desired computer environment without being aware of the physical arrangement of the instance or a relationship with another instance. Moreover, by employing the catalog designed by the administrator for the migration, sizing suitable for the application can be realized without considering know-how on the customization.

### (3) Third Embodiment

In a third embodiment, a system which, if a user requests a configuration change by being motivated by performance deterioration of an instance, automatically performs migration after calculation of a migration measure solving the performance deterioration is provided. In this embodiment, the functionality of calculating a migration measure is the same as the above-described embodiments, but this embodiment is different from them in a point that this embodiment is further provided with a function for automatically performing migration to a calculated migration measure 702 or a recommended catalog.

### Automatic Execution of Migration Measure

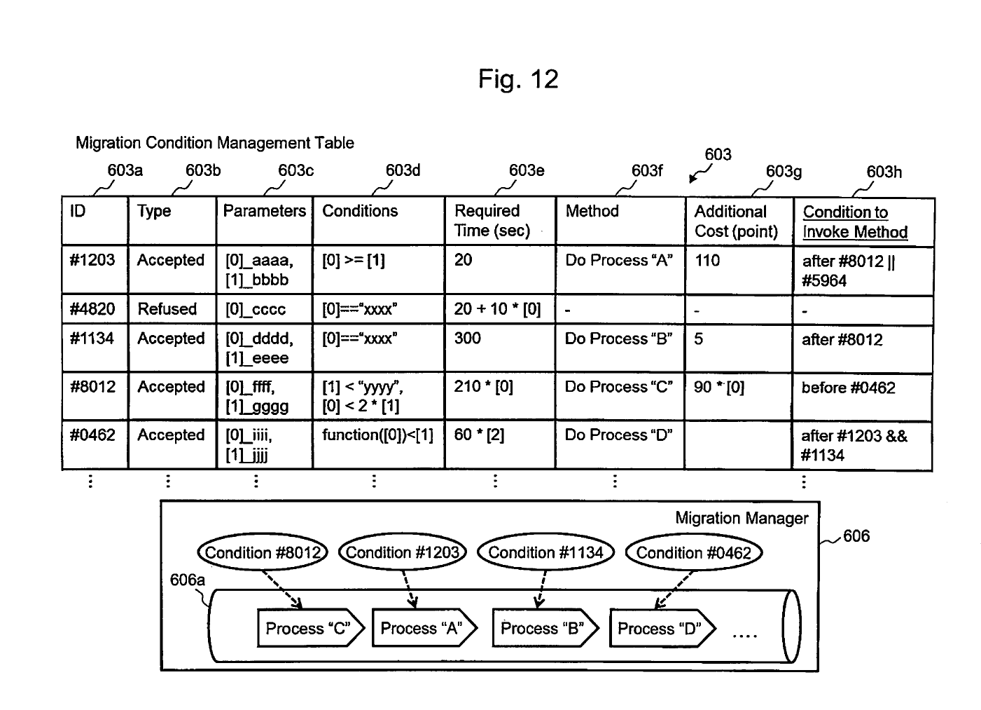

This embodiment is realized as follows. That is, in this embodiment, in the first or second embodiment, a configuration illustrated in FIG. 12 (an execution condition 603h) is added to the migration condition management table 603. Then, the migration management portion 606 performs the migration method matching the condition in accordance with the execution condition 603h.

Regarding the migration condition management table 603, it is only necessary in the first or second embodiment that required time and cost taken for the migration be integrated.

However, in this embodiment, it is necessary to hold the order to execute the migration method 603f determined in accordance with each condition 603d. As a specific example, assume migration from a virtual instance to a physical instance and a change of a format of a storage region from a virtual disk to a volume. In this case, it is necessary to execute a procedure of creating a migration destination volume before a procedure of copying data held by the virtual disk at a migration source to a volume at a migration destination, for example. Moreover, a procedure of installing a device driver for the bare metal server in the OS needs to be executed after the procedure of copying migration target data to the migration destination volume.

Such ordering of the migration methods 603f is expressed as the execution condition 603h for the migration method in this embodiment. FIG. 12 illustrates that a migration method A executed when the migration condition of an identifier “#1203” holds true needs to be executed after a migration condition “#8012” or “#5964” is evaluated in accordance with the applicable execution condition 603h.

On the other hand, the migration management portion 606 newly has an execution queue 606a in this embodiment and holds an execution order of the migration methods 603f scheduled to be executed. The migration management portion 606 refers to the execution condition 603h in the procedure for evaluating the migration condition management table 603 and sets the migration methods 603f in the execution queue 606a. If execution of the migration measure is approved by the user, the migration methods 603f are automatically executed in the order set in the execution queue 606a.

As described above, in this embodiment, if one of the migration measures in FIG. 5 is selected, for example, matching conditions are extracted from FIG. 12. The execution order of the migration methods 603f corresponding to the extracted conditions is automatically determined by the execution condition 603h.

In order to perform scheduling when a migration request is made for a plurality of instances and an exclusive migration work should be performed for the same device, progresses of other migration works may be obtained or a checkpoint where execution is waited for and matched may be provided. However, those checkpoints are limited to those defined by the user or the administrator or that can be mechanically evaluated by the management server.

### Summary of Third Embodiment

According to the third embodiment, a system is realized that, if a user requests a configuration improvement of an instance by being motivated by performance deterioration or performance excess, the instance is automatically migrated to an appropriate configuration. As a result, when each user notices that the performance of the instance the user is using is not appropriate for the performance, it is only necessary to give a clue as a request of a configuration change to the system, and no burden is generated to examine which resource or management function to what degree one by one with the administrator. Moreover, by identifying a factor of the performance influence and proposing a migration measure all the time, the resource efficiency of the entire cloud environment in which many instances are operating can be improved and a configuration suitable for an application used by individual users can be taken. These advantages cannot be realized simply by automation of a configuration change work performed by a user or an administrator.

### (4) Conclusion

(i) In the first embodiment of the present invention, if it is determined by a user that the instance (virtual instance and physical instance) operating on the physical server has performance deterioration or performance excess, or if it is determined to be performance deterioration/excess from the configuration of each instance and performance information of each device (server, storage) (in either cases, a request of a configuration change of the instance is sent to the management server), a proposed change (migration measure) of configuration of the instance is provided to the user (client terminal). More specifically, when the management server receives the above-described request, the server determines whether or not the current instance is competing with another instance for the processing demand by referring to the device management information (FIG. 9) in the physical server in which the current instance to be processed is set. In the case of no competition, if it is possible to extend the configuration on the physical server, a configuration change plan (resource extension plan) of the instance (in this case, a target instance is a virtual instance) is created and presented to the user (see FIG. 5). In the case of competition, migration to another physical server is verified, and a configuration change plan is created and presented. By configuring as above, the user can enjoy a desired processing performance without being worried about physical arrangement of the server or competition with another server.

If the current instance is a physical instance, the configuration cannot be extended/reduced on the operating physical server as the physical instance. In this case, a physical server at a migration destination is searched and the configuration is changed or a configuration change is made to a virtual instance on a physical server.

By configuring as above, the system can be used separately in accordance with a processing request at that time for the large number of business systems such that the processing with a low performance request is integrated to a small number of physical devices by virtualization or processing with a high performance request is stably operated on a bare metal server.

If another physical server is verified as a migration destination, the management server determines whether or not the physical server as a migration destination candidate does not match a migration non-conforming condition (not determined to be Refused in FIG. 8) and also whether or not it as a sufficient resource to create an instance by referring to the migration non-conforming condition (migration condition management information: see FIG. 8) indicating the inappropriateness has a migration destination of the instance. If the physical server as the migration destination candidate matches the migration non-conforming condition (determined to be Refused), the physical server as the migration destination candidate is removed from the candidates for the migration destination. As described above, by determining a condition inappropriate as a migration destination in advance, whether or not the server is appropriate as a physical server at a migration destination can be easily determined.

On the other hand, if the physical server as the migration destination candidate does not match the migration non-conforming condition (not determined to be Refused) and moreover, it is determined that it has sufficient resources, it is further determined whether or not another instance has been set in the physical server as the migration destination candidate. If an existing instance is not set at the migration destination, a configuration change plan for migrating the instance to the physical server as the migration destination candidate is created. If an existing instance has been already set at the migration destination (however, in this case, the recommendation degree is low even if the configuration change plan is created), it is determined whether or not the load tendencies of the existing instance and the current instance compete with each other. If the load tendencies do not compete with each other, the configuration change plan of the instance on the physical server as the migration destination candidate is created. If the load tendencies compete with each other (if operating time of the instances are duplicated and the both cannot operate at the same time), the physical server is determined to be inappropriate as a migration destination and removed from the migration destination candidates. By configuring as above, when an instance is migrated, the operation of the instance at the migration destination is not influenced, and more stable operation can be guaranteed.

(ii) In the second embodiment, a catalog including a plurality of instance configurations recommended in advance is prepared. In this case, the management server extracts an instance configuration proximate to the created configuration change plan from the catalog information, replaces it with the created configuration change plan and provides the proximate instance configuration to the user. By configuring as above, the instance configuration is selected from the catalog, and thus, processing for configuration change becomes predictable and there is no more need to realize an irregular instance configuration. Therefore, the instance migration (extension/reduction) processing can be executed efficiently.

(iii) In the third embodiment, a predetermined parameter, a migration method executed if the parameter satisfies a predetermined condition, and migration execution information (FIG. 12) configured by execution conditions of the migration method are prepared in advance. When one of the configuration change plans (migration measure: see FIG. 5) is selected by a user, the migration method corresponding to an Accepted condition of the configuration change plan is extracted, the migration method is automatically executed in accordance with the corresponding execution condition and the instance according to the configuration change plan is set. By configuring as above, the instance migration is automatically executed and thus, there is a merit that a burden for a user to realize the instance change is eliminated.

(iv) The present invention can be also realized by a program code of software realizing the functions of the embodiments as described above. In this case, a recording medium recording the program code is provided to the system or the device, and a computer (or a CPU or an MPU) of the system or the device reads out the program code stored in the storage medium. In this case, the program code itself read out of the storage medium realizes the above-described functions of the embodiments, and the program code itself and the storage medium recording it constitute the present invention. Storage mediums for supplying such program code include a flexible disk, a CD-ROM, a DVD-ROM, a hard disk, an optical disk, an optomagnetic disk, a CD-R, a magnetic tape, a non-volatile memory card, a ROM and the like.

Moreover, it may be so configured that, on the basis of the instruction of the program code, the OS (operating system) operating on the computer or the like executes a part of or the whole of the actual processing so that the above-described functions of the embodiments are realized by the processing. Furthermore, after the program code read out of the storage medium is written in the memory on the computer, the CPU of the computer or the like executes a part of or the whole of the actual processing on the basis of the instruction of the program code so that the above-described functions of the embodiments are realized by the processing.

Moreover, it may be so configured that the program code of the software realizing the functions of the embodiments is distributed through a network, it is stored in storage means such as the hard disk, memory and the like of the system or the device or a storage medium such as a CD-RW, CD-R and the like, and the computer (or the CPU or the MPU) of the system or the device reads out and executes the program code stored in the storage means or storage medium in use.

Finally, it should be understood that the processes and technologies described herein do not relate to any specific device in essence but can be implemented by any appropriate combination of components. Moreover, general-purpose diversified types of devices can be used in accordance with the teaching described herein. It may be understood that construction of a dedicated device is useful in executing the steps of the methods described herein. Moreover, various inventions can be formed by appropriate combinations of a plurality of constituent elements disclosed in the embodiments. For example, some constituent elements may be deleted from all the constituent elements indicated in the embodiments. Furthermore, the constituent elements across different embodiments may be combined as appropriate. The present invention has been described in relation with specific examples but they are intended for explanation and not for limitation in any viewpoints. Those skilled in the art understand that there can be a large number of combinations of hardware, software, and firmware appropriate for implementing the present invention. For example, the described software can be implemented in a wide range of programs or script languages such as assembler, C/C++, perl, Shell, PHP, Java (registered trademark) and the like.

Furthermore, in the above-described embodiments, control lines and information lines considered to be necessary for explanation are indicated, and not necessarily all the control lines and information lines on a product are indicated. All the configurations may be connected to each other.

In addition, for those having usual knowledge in this technical field, the other implementations of the present invention will become apparent from consideration of the description and the embodiments of the present invention disclosed herein. The described diversified modes and/or components of the embodiments can be used singularly or in any combinations in a computerized storage system having a function for managing data. The description and specific examples are only typical ones, and the range and spirit of the present invention will be indicated in the claims below.

### REFERENCE SIGNS LIST

10 first physical server

11 CPU

12 memory

13a operating system

13b application program

15 fiber channel interface

16 Ethernet interface

20 second physical server

23b virtualization program

50 fiber channel switch

51 storage area network

60 Ethernet switch

61 Ether network

100 first storage apparatus

150 first storage controller

153a response program

153b storage control program

500 management computer

503b management program

504a service management portion

504b integrated service level management portion

504c server device management portion

504d network device management portion

504e storage apparatus management portion

510 client computer

513b client program

601 instance management table

602 service level determination portion

603 migration condition management table

604 performance history storage portion

605 device management table

606 migration management portion

606a execution queue

703 improvement measure list (migration measure list)

801 recommendation catalog

1. A management computer for managing a plurality of physical servers and at least one storage apparatus, comprising:
a storage device for storing configuration information of an instance on the physical server and performance information of the physical server and the storage apparatus; and
a processor for creating a candidate for a configuration change method and providing the result to a user in response to a request of a configuration change of the instance on the physical server, wherein the processor executes:
performance competition determination processing for determining whether or not processing demands are competing between the instance as a target of the configuration change and another instance in a target physical server in which the instance as the configuration change target is set by referring to the performance information stored in the storage device in response to the request of configuration change of the instance;
candidate creation processing for creating a candidate for the configuration change method of the instance as a target of the configuration change on the basis of the result of the performance competition determination processing; and
candidate provision processing for providing the created candidate for the configuration change method to the user.

2. The management computer according to claim 1, wherein
at least one physical server is a first type server having a virtualization mechanism and splitting a resource of the physical server and assigning the split resource to an instance so as to have the instance function as a virtual instance;
at least one physical server other than the first type physical server is a second type server assigning all the resources of the physical server to the instance so as to have the instance function as a physical instance; and
the processor presents a configuration of a virtual instance and/or a physical instance as a candidate for the configuration change method.

3. The management computer according to claim 2, wherein
if it is determined that the processing demands are competing between the instance as the configuration change target and another instance as the result of the performance competition determination processing, the processor examines migration to a physical server different from the target physical server as a migration destination candidate in the candidate creation processing and creates an instance in the migration destination physical server as the configuration change method.

4. The management computer according to claim 3, wherein
the storage device stores a migration non-conforming condition indicating inappropriateness as a migration destination of an instance; and
in the candidate creation processing, the processor executes migration condition inquiry processing for determining whether or not the physical server as the migration destination candidate does not match the migration non-conforming condition and has a sufficient resource for creating an instance and if the physical server as the migration destination candidate matches the migration non-conforming condition, the processor removes the physical server as the migration destination candidate from the candidates.

5. The management computer according to claim 4, wherein as the result of the migration condition inquiry processing, if it is determined that the physical server as the migration destination candidate does not match the migration non-conforming condition and has a sufficient resource, the processor further executes:
existing instance determination processing for determining whether or not another instance has been already set in the physical server as the migration destination candidate;
load tendency determination processing for determining whether or not the load tendencies of the existing instance and the instance as the configuration change target compete with each other if it is determined that the existing instance is in the physical server as the migration candidate; and
creates the migration destination candidate.

6. The management computer according to claim 5, wherein as the result of the existing instance determination processing, if it is determined that the existing instance is not in the physical server as the migration destination candidate, or as the result of the load tendency determination processing, if it is determined that the load tendencies do not compete with each other between the existing instance and the instance as the configuration change target, the processor chooses migration to the physical server as the migration destination candidate as a candidate for the configuration change method.

7. The management computer according to claim 2, wherein
the configuration change target instance is a virtual instance;
as the result of the performance competition determination processing, if it is determined that the processing demands do not compete with each other between the instance as the configuration change target and another instance, the processor further executes configuration change determination processing for determining whether or not the configuration change of the instance is possible in the target physical server; and
as the result of the configuration change determination processing, if it is determined that the configuration change is possible, the processor creates a configuration change method of an instance obtained by configuration change on the target physical server as a candidate in the candidate creation processing.

8. The management computer according to claim 2, wherein
the storage device includes catalog information including a plurality of recommended instance configurations; and
in the candidate creation processing, the processor extracts an instance configuration proximate to the created configuration change method candidate from the catalog information, replaces it with the created configuration change method and in the candidate provision processing, provides the proximate instance configuration to the user.

9. The management computer according to claim 2, wherein
the storage device stores a plurality of sets of migration execution information, each composed of a migration method executed if a predetermined parameter satisfies a predetermined condition and an execution condition of the migration method; and
if the created configuration change method candidate is selected by the user, the processor further extracts the migration method satisfied by the parameter of the selected candidate and the execution condition of the migration method from the plurality of sets of the migration execution information and executes the extracted migration method in accordance with the extracted execution condition.

10. A computer system having a plurality of physical servers, at least one storage apparatus, at least one client computer, and the management computer according to claim 2, wherein
the management computer transmits information of the created configuration change method candidate to the client computer; and
the client computer displays the configuration change method candidate on a display device.

11. 1] The computer system according to claim 10, wherein
the information of the configuration change method candidate displayed on the client computer includes change type information of the instance indicating which of change forms, that is, a change from a virtual instance to a physical instance, a configuration change of the virtual instance in the same physical server, and migration of the virtual instance to another physical server, the configuration change method candidate is, information indicating stability of a resource, information of time required for the change, and information of a cost required for the change.

12. An instance management method in a computer system, having a plurality of physical servers, at least one storage apparatus, and a management computer for managing the devices, for managing an instance set on the physical server, comprising:
a step of obtaining by the management computer performance information of the physical server and the storage apparatus and configuration information of the instance on the physical server and storing the information in a memory;
a performance competition determination step of receiving by the management computer a request for a configuration change of an instance, referring to the performance information stored in the memory in response to the request, and determining whether or not processing demands compete with each other between the configuration change target instance and another instance in a target physical server in which the instance as a configuration change target is set;
a candidate creation step of creating by the management computer a candidate for a configuration change method of the configuration change target instance on the basis of an execution result of the performance competition determination; and
a candidate provision step of providing by the management computer the created configuration change method candidate to a client computer.

13. The instance management method according to claim 12, wherein
at least one physical server is a first type server having a virtualization mechanism and splitting a resource of the physical server and assigning the split resource to an instance so as to have the instance function as a virtual instance;
at least one physical server other than the first type physical server is a second type server assigning all the resources of the physical server to the instance so as to have the instance function as a physical instance; and
the management computer presents a configuration of a virtual instance and/or a physical instance as a candidate for the configuration change method.

14. The instance management method according to claim 13, wherein as the result of processing of the performance competition determination step, if it is determined that an instance as the configuration change target competes with another instance in a processing demand, in the candidate creation step, the management computer examines migration to a physical server different from the target physical server as a migration destination candidate and creates an instance in a physical server at a migration destination as the configuration change method.

15. The instance management method according to claim 14, wherein
the management computer holds information of a migration non-conforming condition indicating inappropriateness as a migration destination of an instance; and
in the candidate creation step, the management computer executes migration condition inquiry processing for determining whether or not a physical server as the migration destination candidate does not match the migration non-conforming condition and has a sufficient resource for creating an instance, and if the physical server as the migration destination candidate matches the migration non-conforming condition, removes the physical server as the migration destination candidate from the candidates.
